(19) United States
(12) Patent Application Publication
(10) Pub. No.: US 2024/0274830 A1
(43) Pub. Date: Aug. 15, 2024

(54) ARTICLES AND METHODS RELATED TO LITHIUM ELECTRODE PROTECTION

(71) Applicant: Sion Power Corporation, Tucson, AZ (US)

(72) Inventors: Zachary E. Lawrence, Tucson, AZ (US); Yuriy V. Mikhaylik, Tucson, AZ (US); Jeremy H. Hartenberg, Tucson, AZ (US); Michael David Whitney, Marana, AZ (US)

(73) Assignee: Sion Power Corporation, Tucson, AZ (US)

(21) Appl. No.: 18/403,276

(22) Filed: Jan. 3, 2024

Related U.S. Application Data
(60) Provisional application No. 63/438,057, filed on Jan. 10, 2023.

(51) Int. Cl. H01M 4/62; H01M 4/02; H01M 4/38

(52) U.S. Cl. CPC H01M 4/628; H01M 4/382; H01M 2004/021

(57) ABSTRACT

Articles and methods for forming protective layers for use in electrochemical cells are provided. As described herein, a protective layer may comprise a ceramic (e.g., comprising an alkali metal carbonate and/or an alkaline earth metal carbonate) and a plurality of ionically insulating particles (e.g., comprising aluminum oxide). The ceramic may coat at least a portion of the surfaces of the ionically insulating particles, and the ionically insulating particles may strain this portion of the crystal lattice structure of the ceramic, thus increasing the ion conductivity of the protective layer compared to an otherwise equivalent protective layer absent the ceramic coating.

### RELATED APPLICATIONS

This application claims priority to U.S. Provisional Application No. 63/438,057 filed Jan. 10, 2023, which is incorporated herein by reference in its entirety.

### FIELD

The present disclosure generally relates to articles and methods for forming protective layers for use in electrochemical cells.

### BACKGROUND

Electrochemical cells generate electrical energy from electrochemical reactions that occur at the cathode and cathode. Some electrochemical cells include anodes that include lithium. Lithium can be reactive with species present in the ambient environment. However, existing layers that protect lithium from exposure to such species can have an undesirably low ionic conductivity. Thus, improvements are needed.

### SUMMARY

The subject matter of the present disclosure involves, in some cases, interrelated products, alternative solutions to a particular problem, and/or a plurality of different uses of one or more systems and/or articles.

In some embodiments, an article for use in an electrochemical cell is provided. The article comprises an electroactive layer comprising lithium and a protective layer comprising a ceramic and a plurality of ionically insulating particles. Each particle in the plurality of ionically insulating particles comprises a surface. The ceramic coats at least a portion of the surfaces of the ionically insulating particles. The ionically insulating particles and having surfaces coated by the ceramic strain the crystal lattice structure of the ceramic coating their surfaces. The protective layer is conductive to lithium ions.

In some embodiments, an article for use in an electrochemical cell comprises an electroactive layer comprising lithium and a protective layer comprising a lithium aluminate. The protective layer is conductive to lithium ions.

In some embodiments, an article is provided. The article comprises an electroactive layer comprising lithium and a protective layer comprising a ceramic and a plurality of ionically insulating particles. The ceramic comprises an alkali metal carbonate and/or an alkaline earth metal carbonate. The plurality of ionically insulating particles comprises aluminum oxide. The protective layer is conductive to lithium ions.

In some embodiments, a composition for forming a protective layer for an electroactive lithium layer is provided. The protective layer comprises a ceramic and a plurality of ionically insulating particles. The ceramic comprises an alkali metal carbonate and/or an alkaline earth metal carbonate. The plurality of ionically insulating particles comprises aluminum oxide. Each particle in the plurality of ionically insulating particles comprises a surface. The ceramic coats at least a portion of the surfaces of the ionically insulating particles. The ionically insulating particles and having surfaces coated by the ceramic strain the crystal lattice structure of the ceramic coating their surfaces. The protective layer is conductive to lithium ions.

In some embodiments, a method is provided. The method comprises heating a mixture comprising a ceramic and a plurality of ionically insulating particles to a temperature above a melting point of the ceramic and below a melting point of the ionically insulating particles, cooling the mixture to room temperature, and forming a fine powder from the mixture. After cooling, the ceramic coats at least a portion of the surfaces of the ionically insulating particles. After cooling, the ionically insulating particles and having surfaces coated by the ceramic strain the crystal lattice structure of the ceramic coating their surfaces.

In some embodiments, a method comprises heating a mixture comprising a ceramic and a plurality of ionically insulating particles to a temperature above a melting point of the ceramic and below a melting point of the plurality of ionically insulating particles, cooling the mixture to room temperature, and forming a fine powder from the mixture. The ceramic comprises an alkali metal carbonate and/or an alkaline earth metal carbonate. The plurality of ionically insulating particles comprises aluminum oxide.

Other advantages and novel features of the present disclosure will become apparent from the following detailed description of various non-limiting embodiments of the disclosure when considered in conjunction with the accompanying figures.

### BRIEF DESCRIPTION OF THE DRAWINGS

Non-limiting embodiments of the present disclosure will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the disclosure shown where illustration is not necessary to allow those of ordinary skill in the art to understand the disclosure. In the figures:

FIG. 1 illustrates an article comprising an electroactive layer and a protective layer, according to some embodiments;

FIG. 2 illustrates an exemplary embodiment of an electrochemical cell comprising the article in FIG. 1, according to some embodiments;

FIG. 3 illustrates an article comprising an electroactive layer and a protective layer comprising a plurality of ionically insulating particles that are at least partially coated with a ceramic causing the ceramic to have a strained crystal lattice structure, according to some embodiments;

FIG. 4 illustrates an article comprising an electroactive layer and a protective layer comprising a plurality of particles;

FIG. 5 illustrates the process for preparing a mixture comprising a ceramic and ionically insulating particles for use as a protective layer, according to some embodiments;

FIGS. 6-7 illustrate a method of depositing particles onto an electroactive layer, according to some embodiments; and

FIG. 8 shows the lithium ion conductivity as a function of carbonate salt content for two different types of compositions.

### DETAILED DESCRIPTION

Articles and methods for forming protective layers for use in electrochemical cells are provided. As described herein, a protective layer may comprise a ceramic (e.g., comprising an alkali metal carbonate and/or an alkaline earth metal carbonate) and a plurality of ionically insulating particles (e.g., comprising aluminum oxide). The ceramic may coat at least a portion of the surfaces of the ionically insulating particles. In some embodiments, the ionically insulating particles strain the crystal lattice structure of the ceramic coating their surfaces, thus increasing the ionic conductivity of the protective layer compared to an otherwise equivalent protective layer absent the ceramic coating.

In some embodiments, the protective layers described herein may increase battery performance (e.g., cycle life, recharge ratio, coulombic losses, etc.) compared to an otherwise equivalent battery absent such a protective layer. Without wishing to be bound by any particular theory, it is believed that increased ionic conductivity in the protective layer allows more ions to pass per unit time, which may increase the cycle life and/or the recharge ratio of the battery. It is also possible for increased ionic conductivity to reduce relative coulombic losses during recharging.

The disclosed protective layers may be incorporated into electrochemical cells, for example, electrochemical cells present in primary batteries or secondary batteries, the latter of which can be charged and discharged numerous times. In some embodiments, the materials, systems, and methods described herein can be used in association with lithium batteries (e.g., lithium-lithium transition metal oxide batteries, lithium-lithium transition metal phosphate batteries, lithium-sulfur batteries, lithium-ion batteries). The electrochemical cells described herein may be employed in various applications, for example, making or operating cars, computers, personal digital assistants, mobile telephones, watches, camcorders, digital cameras, thermometers, calculators, laptop BIOS, communication equipment or remote car locks. It should be appreciated that the protective layers described herein may be applied to any lithium-based battery, as well as other alkali metal-based batteries.

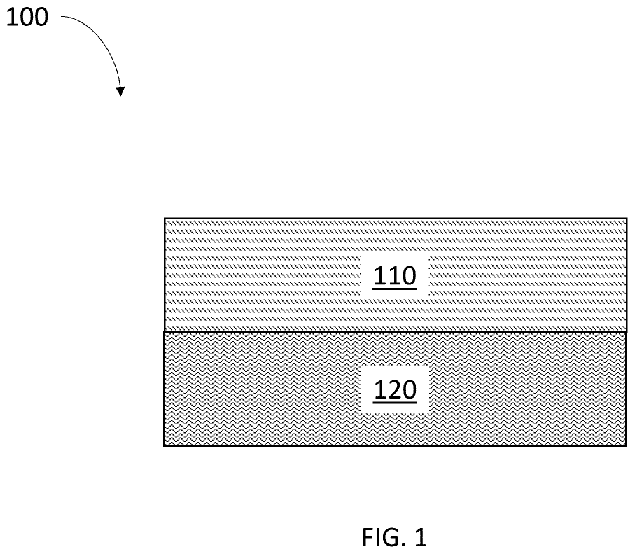

FIG. 1 shows one non-limiting example of an article 100 comprising a protective layer 110 disposed on an electroactive layer 120. The protective layer may comprise a ceramic, a plurality of ionically insulating particles, and/or a lithium aluminate. In some embodiments, the protective layer is deposited onto a surface of the electroactive layer, such as a surface opposite a current collector. The electroactive layer may comprise a naturally occurring passivation layer. In such embodiments, the protective layer may be deposited on the naturally occurring passivation layer and further passivate the electroactive layer. It is also possible for the protective layer to be deposited on another type of layer (e.g., a silylated sulfonic acid coating, such as that described in WO 2022/081301, which is incorporated herein by reference for all purposes). In some embodiments, the electroactive layer comprises lithium. In such embodiments, the protective layer may be conductive to lithium ions.

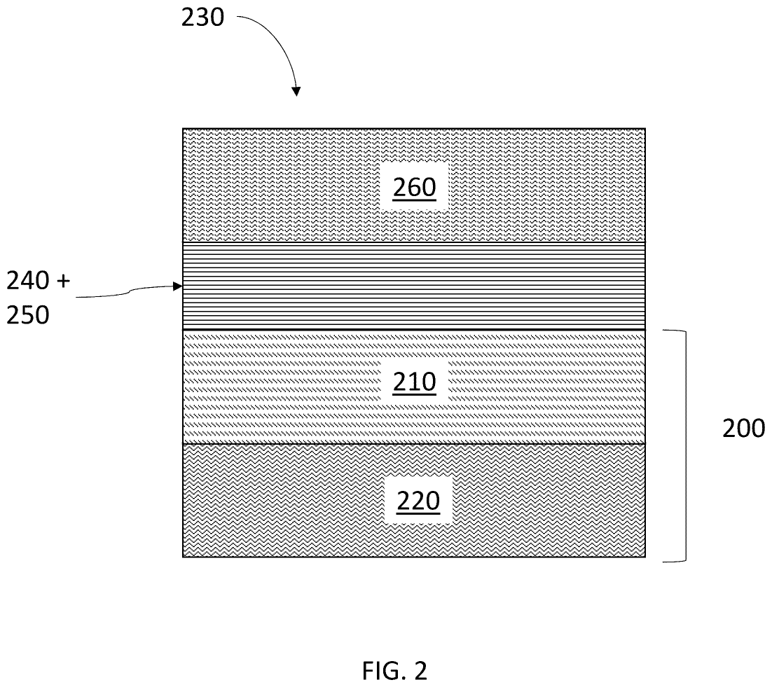

FIG. 2 shows one non-limiting example of an article 200 that is positioned in an electrochemical cell 230. The article 200 comprises a protective layer 210 and an electroactive layer 220. The protective layer may comprise a ceramic, a plurality of ionically insulating particles, and/or a lithium aluminate. The electrochemical cell 230 further comprises an electrolyte 240 disposed in the pores of a separator 250, and an electrode 260.

The protective layer may protect the electroactive layer from direct contact with and/or reduce direct contact of the electroactive layer with the electrolyte. This may reduce the frequency of and/or eliminate deleterious reactions between species present in the electrolyte and the electroactive layer. In some embodiments, the protective layer provides this protection while also allowing appreciable conduction of ions (e.g., ions to be incorporated into the electroactive layer after undergoing a redox reaction that occurs during charging or discharging, ions generated from the electroactive layer upon a redox reaction that occurs during charging or discharging). In some instances, the protective layer is substantially non-porous. However, in other embodiments, the protective layer may be porous and/or may permit contact of the electroactive layer with an electrolyte and/or a species within the electrolyte; however, the protective layer may still promote an overall increase in cycle life.

If a separator is present, it may be used to mechanically separate the protective layer from the electrode while permitting the flow of ions between the electrode and the electroactive layer.

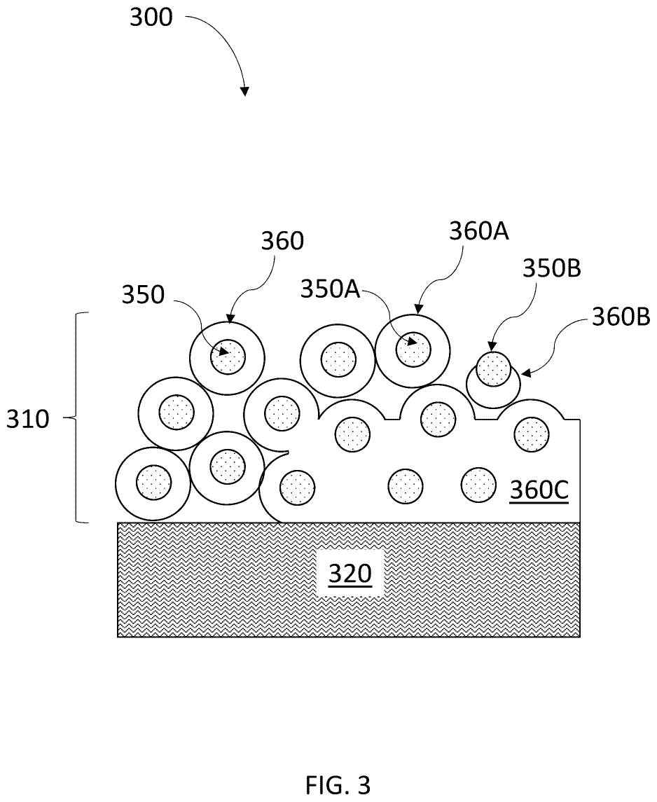

FIG. 3 shows one further non-limiting example of an article comprising a protective layer and an electroactive layer. In FIG. 3, the protective layer 310 coats the electroactive layer 320. The protective layer 310 comprises a plurality of ionically insulating particles 350 and a ceramic 360. In some embodiments, the ceramic coats at least a portion of (e.g., some or all of) the surfaces of the ionically insulating particles. The coating may be conformal or non-conformal, and may or may not fill in some or all of the gaps between the ionically insulating particles. For instance, the ionically insulating particle 350A is conformally coated by the ceramic 360, but the ionically insulating particle 350B is only partially coated by the ceramic 360B. As another example, the ceramic 360C fills in the gaps between a number of ionically insulating particles in the lower right hand portion of the protective layer 310.

In some embodiments, a protective layer comprises particles that themselves comprise multiple ionically insulating particles that are adhered together (and, possibly, enveloped) by a ceramic. In some embodiments, the ionically insulating particles strain the crystal lattice structure of the ceramic coating their surfaces. Such strain may increase the ionic conductivity of the protective layer, which may increase the cycle life and/or recharge ratio of the battery. In some embodiments, such strain reduces the relative coulombic losses during recharging.

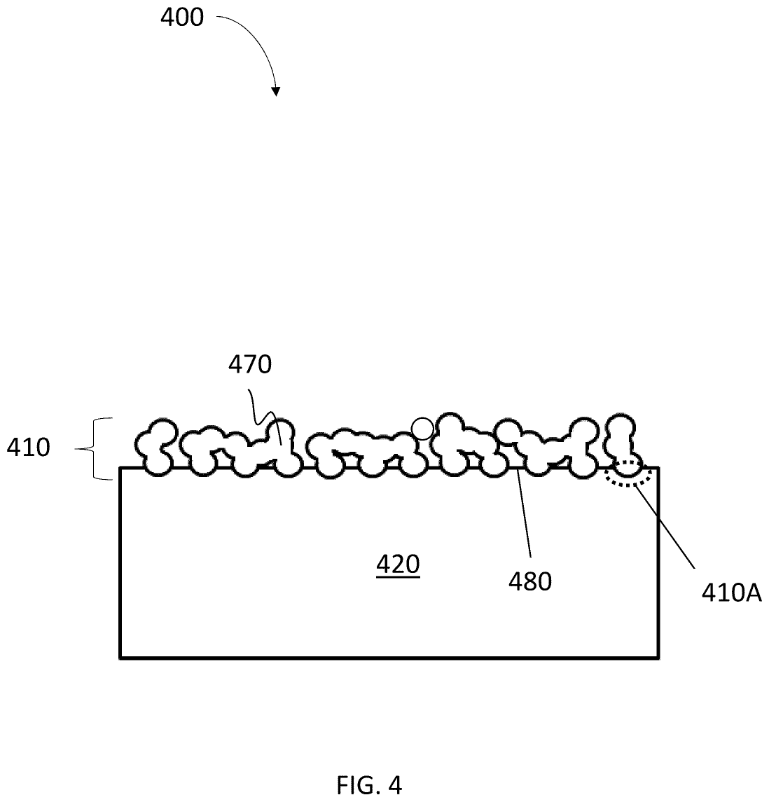

In some embodiments, at least a portion of the protective layer is at least partially embedded within the electroactive layer. For example, as illustrated in FIG. 4, an article 400 comprises a protective layer 410 and an electroactive layer 420. As shown therein, at least portions of the protective layer may be embedded in the surface of the electroactive layer (e.g., portion 410A of the protective layer 410). In some cases, embedding of the protective layer into the electroactive layer may occur by a deposition process described herein.

In some embodiments, a protective layer comprises a plurality of particles (e.g., particles comprising a ceramic, an ionically insulating material, and/or a lithium aluminate) that are fused. For example, as shown illustratively in FIG. 4, at least a portion of the plurality of particles 470 are fused (e.g., fused ionically insulating particles, fused particles comprising a lithium aluminate). All or a portion of the fused particles may comprise a ceramic that coats at least a portion of (e.g., some or all of) the surfaces of the fused particles and the particles may strain the crystal lattice structure of the ceramic coating their surfaces.

In some embodiments, the plurality of particles (e.g., fused ionically insulating particles, fused particles comprising a lithium aluminate) are at least partially embedded in the electroactive layer. As an example and as described in more detail below, the protective layer may be formed at least in part by subjecting the electroactive layer to particles traveling at a certain velocity such that the particles impinge upon the electroactive layer upon contact, and/or fuse with one another upon collision. As shown in this illustrative aspect, the protective layer 410 has a first surface 480, which may be adjacent the electroactive layer 420. The plurality of particles (e.g., the plurality of fused particles) may, in some embodiments, contact and/or be embedded in at least a portion of the electroactive layer 420 at the first surface 480.

In some embodiments, a composition for forming a protective layer is provided (e.g., a composition that may be deposited onto an electroactive lithium layer to form a protective layer thereof). The composition may comprise one or more of the components of the protective layers described above and elsewhere herein (e.g., a plurality of ionically insulating particles, a ceramic, a lithium aluminate).

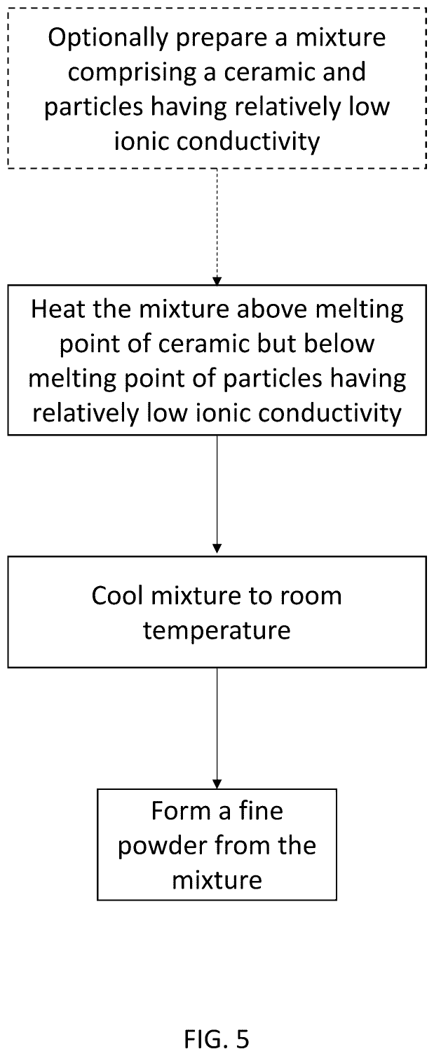

FIG. 5 shows one exemplary process for fabricating a protective layer. In some embodiments, a mixture comprising a ceramic and a plurality of ionically insulating particles is optionally prepared prior to heating the mixture, e.g., by sieving and/or milling the mixture (e.g., roll milling). The method may comprise heating the mixture comprising the ceramic and the plurality of ionically insulating particles above the melting point of the ceramic but below the melting point of the ionically insulating particles. This step may be performed when the mixture is disposed in a crucible and/or after pressing the mixture into a crucible. In some embodiments, upon melting the ceramic into a molten state, the molten ceramic wets the surface of the ionically insulating particles. The method may further comprise cooling the mixture to room temperature. This cooling may result in the formation of a solid mixture comprising both the ceramic and the particles and/or comprising a lithium aluminate. Subsequently, the solid mixture may be broken down into particles, such as a fine powder. The resulting particles may include both the ionically insulating particles and the ceramic, which may coat at least a portion of the surfaces of the ionically insulating particles after being broken down. Some such particles comprise multiple ionically insulating particles (and/or portions thereof) bound together by the ceramic. It is also possible for the fine powder to, additionally or alternatively, include a lithium aluminate. The coated particles may be suitable for forming a protective layer as described herein. In some embodiments, the particles are deposited onto a layer (e.g., an electroactive layer, a separator, a layer to be positioned adjacent to and/or laminated to an electroactive layer) by aerosol deposition or by another suitable method.

In some embodiments, the articles described herein comprise a protective layer deposited on the surface of another layer, such as an electroactive material layer (e.g., lithium anode). The protective layer may be of any suitable thickness. For example, in some cases, the thickness of the protective layer is greater than or equal to 0.01 μm, greater than or equal to 0.05 μm, greater than or equal to 0.1 μm, greater than or equal to 0.5 μm, greater than or equal to 1 μm, greater than or equal to 2 μm, greater than or equal to 4 μm, or greater than or equal to 8 μm. In some embodiments, the thickness of the protective layer is less than or equal to 10 μm, less than or equal to 8 μm, less than or equal to 4 μm, less than or equal to 2 μm, less than or equal to 1 μm, less than or equal to 0.5 μm, less than or equal to 0.1 μm, or less than or equal to 0.05 μm. Combinations of the above-referenced ranges are also possible (e.g., greater than or equal to 0.1 μm and less than or equal to 10 μm, or greater than or equal to 2 μm and less than or equal to 4 μm). Other ranges are also possible.

The ranges described in the preceding paragraph may characterize the average thickness of the protective layer and/or the thickness of any given portion of the protective layer.

In some embodiments, a protective layer may be porous or comprise a porous region. In other words, the protective layer may comprise a plurality of pores. It is also possible for a protective layer to be nonporous (i.e., lack pores) and/or comprise a nonporous region. As used herein, a “pore” generally refers to a conduit, void, or passageway at least partially surrounded by a solid material and capable of being occupied by a liquid or gas. For the purposes of this disclosure, voids within a material that are completely surrounded by the material (and thus, not accessible from outside the material, e.g., closed cells) are not considered pores. It should be understood that, in cases where the protective layer comprises an agglomeration of particles, pores include both the interparticle pores (i.e., those pores defined between particles when they are packed together, e.g., interstices) and intraparticle pores (e.g., those pores lying within the envelopes of the individual particles). Pores may comprise any suitable cross-sectional shape such as, for example, circular, elliptical, polygonal (e.g., rectangular, triangular, etc.), irregular, and the like. Pore size distribution and volume can be measured via mercury intrusion porosimetry using ASTM Standard Test D4284-07.

The pores of a protective layer or a portion of the protective layer may be of any of a variety of suitable sizes (e.g., measured as an average cross-sectional pore diameter). For example, in some cases, the pores of a porous portion can be sufficiently large to allow for the passage of liquid electrolyte thereinto due to, for example, capillary forces. In addition, in some embodiments, the pores may be smaller than millimeter-scale or micron-scale. In some embodiments, the pores have a mean average diameter (i.e., an average cross-sectional diameter) of greater than or equal to 0.2 nm, greater than or equal to 0.5 nm, greater than or equal to 0.75 nm, greater than or equal to 1 nm, greater than or equal to 2 nm, greater than or equal to 5 nm, greater than or equal to 10 nm, greater than or equal to 20 nm, greater than or equal to 30 nm, greater than or equal to 40 nm, greater than or equal to 50 nm, greater than or equal to 75 nm, greater than or equal to 100 nm, greater than or equal to 200 nm, greater than or equal to 300 nm, greater than or equal to 400 nm, greater than or equal to 500 nm, or greater than or equal to 750 nm. In some embodiments, the pores have an average cross-sectional diameter of less than or equal to 1 μm, less than or equal to 750 nm, less than or equal to 500 nm, less than or equal to 400 nm, less than or equal to 300 nm, less than or equal to 200 nm, less than or equal to 100 nm, less than or equal to 75 nm, less than or equal to 50 nm, less than or equal to 40 nm, less than or equal to 30 nm, less than or equal to 20 nm, less than or equal to 10 nm, less than or equal to 5 nm, less than or equal to 2 nm, less than or equal to 1 nm, less than or equal to 0.75 nm, or less than or equal to 0.5 nm. Combinations of the above-referenced ranges are also possible (e.g., greater than or equal to 0.2 nm and less than or equal to 1 μm). Other ranges are also possible. The cross-sectional diameter of a pore and the average cross-sectional pore diameter of a protective layer can be measured via mercury intrusion porosimetry using ASTM Standard Test D4284-07.

As described above, in some embodiments, a protective layer comprises at least some particles that are fused. The fused particles may comprise a ceramic and/or an ionically insulating material having as described herein (e.g., particles coated with a ceramic). The terms “fuse” and “fused” (and “fusion”) are given their typical meaning in the art and generally refers to the physical joining of two or more objects (e.g., particles) such that they form a single object. For example, in some embodiments, the volume occupied by a single particle (e.g., the entire volume within the outer surface of the particle) prior to fusion is substantially equal to half the volume occupied by two fused particles. Those skilled in the art would understand that the terms “fuse”, “fused”, and “fusion” do not refer to particles that simply contact one another at one or more surfaces, but particles wherein at least a portion of the original surface of each individual particle can no longer be discerned from the other particle.

In some cases, a protective layer comprises particles that are fused such that at least a portion of the plurality of particles form a continuous pathway across the protective layer (e.g., between opposing surfaces of a protective layer). A continuous pathway may include, for example, an ionically-conductive pathway from a first surface to a second, opposing surface of the layer in which there are substantially no gaps, breakages, or discontinuities in the pathway. Whereas fused particles across a layer may form a continuous pathway, a pathway including packed, unfused particles would have gaps or discontinuities between the particles that would not render the pathway continuous. In certain embodiments, the protective layer includes a plurality of such continuous pathways across the layer. In some embodiments, at least 10 vol %, at least 30 vol %, at least 50 vol %, or at least 70 vol % of the protective layer comprises one or more continuous pathways comprising fused particles (e.g., which may comprise an ionically conductive material, such as an ionically conductive ceramic). In some embodiments, less than or equal to 100 vol %, less than or equal to 90 vol %, less than or equal to 70 vol %, less than or equal to 50 vol %, less than or equal to 30 vol %, less than or equal to 10 vol %, or less than or equal to 5 vol % of the protective layer comprises one or more continuous pathways comprising fused particles. Combinations of the above-referenced ranges are also possible (e.g., at least 10 vol % and less than or equal to 100 vol %). In some cases, 100 vol % of the protective layer comprises one or more continuous pathways comprising fused particles. That is to say, in some embodiments, the protective layer consists essentially of fused particles (e.g., the protective layer comprises substantially no unfused particles). In some embodiments, substantially all of the particles in a protective layer are unfused.

In some embodiments, the protective layer may comprise a first portion comprising fused particles and a second portion comprising unfused particles. For example, in some such embodiments, a plurality of particles may be deposited on an underlying layer such that at least a portion of the first portion of the plurality of particles fuse and such that the second portion of the plurality of particles do not substantially fuse. In an exemplary embodiment, a plurality of particles comprising ionically conductive particles may be deposited on an underlying layer such that at least a portion of the ionically conductive particles fuse. The fused and unfused particles may each comprise the coated particles described herein (e.g., particles with at least a portion of their surfaces coated with a ceramic, particles comprising a lithium aluminate).

Those skilled in the art would be capable of selecting suitable methods for determining if the particles are fused including, for example, performing Confocal Raman Microscopy (CRM). CRM may be used to determine the percentage of fused areas within a protective layer described herein. For instance, in some embodiments, the fused areas may be less crystalline (more amorphous) compared to the unfused areas (e.g., particles) within the layer, and may provide different Raman characteristic spectral bands than those of the unfused areas. In some embodiments the fused areas may be amorphous and the unfused areas (e.g., particles) within the protective layer may be crystalline. Crystalline and amorphous areas may have peaks at the same/similar wavelengths, while amorphous peaks may be broader/less intense than those of crystalline areas. In some embodiments, the unfused areas may include spectral bands substantially similar to the spectral bands of the bulk particles prior to formation of the protective layer (the bulk spectrum). For example, an unfused area may include peaks at the same or similar wavelengths and having a similar area under the peak (integrated signal) as the peaks within the spectral bands of the particles prior to formation of the layer. An unfused area may have, for instance, an integrated signal (area under the peak) for the largest peak (the peak having the largest integrated signal) in the spectrum that may be, e.g., within at least 70%, at least 75%, at least 80%, at least 85%, at least 90%, at least 95%, or at least 97% of value of the integrated signal for the corresponding largest peak of the bulk spectrum. By contrast, the fused areas may include spectral bands different from (e.g., peaks at the same or similar wavelengths but having a substantially different/lower integrated signal than) the spectral bands of the particles prior to formation of the protective layer. A fused area may have, for instance, an integrated signal (area under the peak) for the largest peak (the peak having the largest integrated signal) in the spectrum that may be, e.g., less than 50%, less than 60%, less than 70%, less than 75%, less than 80%, less than 85%, less than 90%, less than 95%, or less than 97% of value of the integrated signal for the corresponding largest peak of the bulk spectrum. In some embodiments, 2-dimensional or 3-dimensional mapping of CRM may be used to determine the percentage of fused areas in the protective layer (e.g., the percentage of area, within a minimum cross-sectional area, having an integrated signal for the largest peak of the spectrum that differs from that for the particles prior to formation of the protective layer, as described above). The minimum cross-sectional area of the layer used for such an analysis may be, for example, at least 600 μm², at least 900 μm², at least 1000 μm², at least 2000 μm², at least 3000 μm², at least 5000 μm², at least 7000 μm², or at least 10,000 μm², and the intervals of measurement (spatial resolution) within the area may be, for example, 1 μm² or less, 2 μm² or less, 4 μm² or less, 6 μm² or less, or 9 μm² or less. (If a 3-dimensional image is obtained, the minimum volume of the layer used for such an analysis may be, for example, at least 600 μm³, at least 900 μm³, at least 1000 μm³, at least 2000 μm³, at least 3000 μm³, at least 5000 μm³, at least 7000 μm³, or at least 10,000 μm³, and the intervals of measurement (spatial resolution) within the volume may be, for example, 1 μm³ or less, 4 μm³ or less, 8 μm³ or less, 16 μm³ or less, 27 μm³ or less, or 64 μm³ or less). An average of at least 3, 5, or 7 images may be used to determine percentage of fused area for a particular protective layer.

In some embodiments, the presence of fused particles in a protective layer material may be determined by determining the conductivity of the layer. For instance, a protective layer comprising fused particles may have an average conductivity greater than an average conductivity of a protective layer in which the particles are not fused, all other factors being equal. An average of at least 3, 5, or 7 measurements may be used to determine the conductivity for a particular protective layer.

In some embodiments, a protective layer comprises particles and at least a portion of the particles in the protective layer, and/or at least a portion of the surfaces of such particles, are in contact (e.g., direct contact) with an electroactive layer. This configuration can allow transport of ions (e.g., metal ions, such as lithium ions) directly from the particles to the electroactive layer. In some embodiments, at least a portion of the particles is embedded within the electroactive layer. For example, in some cases, at least 0.1 vol % of the particles of a protective layer are embedded within the electroactive layer. In some embodiments, at least 1 vol %, at least 5 vol %, at least 10 vol %, or at least 20 vol % of the particles are embedded within the protective layer. In some embodiments, less than or equal to 25 vol %, less than or equal to 20 vol %, less than or equal to 15 vol %, or less than or equal to 10 vol % of the particles are embedded within the electroactive layer. Combinations of the above-referenced ranges are also possible (e.g., between 0.1 vol % and 25 vol %). Other ranges are also possible. Methods for determining the volume percentage of particles within a protective layer are known within the art and may include dissecting a protective layer and imaging with, for example, a scanning electron microscope.

In some embodiments, a protective layer includes one surface that is in contact with an electroactive layer and one surface that is in contact with an additional layer or component of an electrode or electrochemical cell (e.g., an electrolyte, a separator). In some embodiments, a protective layer comprises a plurality of particles, and at least some of the particles (e.g., fused coated particles) comprises a first portion in direct contact with the electroactive layer at one surface and a second portion in direct contact with the additional layer or component of the electrochemical cell at the second surface. For example, a protective layer may comprise fused particles, and the second portion of at least some of the fused particles may be in direct contact with an electrolyte.

In some embodiments, the protective layer is permeable to a liquid electrolyte (e.g., a liquid electrolyte to be used in an electrochemical cell including the protective layer). For example, in some embodiments, the protective layer absorbs (e.g., within the pores of the protective layer) greater than or equal to 1 wt %, greater than or equal to 5 wt %, greater than or equal to 10 wt %, greater than or equal to 20 wt %, or greater than or equal to 25 wt % of a liquid electrolyte versus the total weight of the protective layer. In certain embodiments, the protective layer absorbs less than 30 wt %, less than 20 wt %, less than 10 wt %, or less than 5 wt % of a liquid electrolyte versus the total weight of the protective layer. Combinations of the above-referenced ranges are also possible (e.g., greater than or equal to 1 wt % and less than or equal to 30 wt %). Other ranges are also possible. The amount of liquid electrolyte absorbed by the protective layer may be determined measuring the difference in weight of the protective layer after absorbing the liquid electrolyte (e.g., after exposing the layer to the electrolyte for 1 hour at ambient temperature and pressure) versus the weight of the layer before absorbing the liquid electrolyte.

In some embodiments, the protective layer is conductive (e.g., to lithium ions). In some cases, the conductivity of the protective layer may increase the recharge ratio of an electrochemical cell in comparison to an otherwise-equivalent electrochemical cell lacking the protective layer. For instance, in some embodiments, the protective layer increases the recharge ratio of the electrochemical cell by greater than or equal to 0.1%, greater than or equal to 0.2%, greater than or equal to 0.3%, or greater than or equal to 0.4%. In some embodiments, the protective layer increases the recharge ratio of the electrochemical cell by less than or equal to 0.5%, less than or equal to 0.4%, less than or equal to 0.3%, or less than or equal to 0.2%. Combination of the above-referenced ranges are also possible (e.g., greater than or equal to 0.1% and less than or equal to 0.5%). Other ranges are also possible. The recharge ratio of an electrochemical cell may be determined according to the procedure described in Example 3.

In some embodiments, including the protective layer in an electrochemical cell may reduce the relative coulombic losses during recharging in comparison to an otherwise-equivalent electrochemical cell lacking the protective layer. In some embodiments, the protective layer reduces the relative coulombic losses by a factor greater than or equal to 5, greater than or equal to 6, or greater than or equal to 7, compared to an otherwise-equivalent electrochemical cell lacking the protective layer. In some embodiments, the protective layer reduces the relative coulombic losses by a factor less than or equal to 8, less than or equal to 7, or less than or equal to 6, compared to an otherwise-equivalent electrochemical cell lacking the protective layer. Combinations of the above-referenced ranges are possible (e.g., greater than or equal to 5 and less than or equal to 8). Other ranges are also possible. The coulombic loss of an electrochemical cell may be determined according to the procedure described in Example 3.

The protective layer and the composition for forming a protective layer can be formed of a variety of types of materials. In some embodiments, the materials from which the protective layer (and/or composition for forming the protective layer) is formed may be selected to allow ions (e.g., electrochemically active ions, such as lithium ions) to pass through the material but to substantially impede electrons from passing across the material. By “substantially impedes”, in this context, it is meant that the material allows lithium ion flux at least ten times greater than electron passage. The protective layer (and/or composition for forming the protective layer) may comprise, for example, an ion-conductive material (e.g., to facilitate the transfer of ions between materials on either side of the protective layer). Advantageously, such materials may be capable of conducting specific cations (e.g., lithium cations) while not conducting certain anions (e.g., polysulfide anions) and/or may be capable of acting as a barrier to an electrolyte and/or a polysulfide species for the electroactive layer.

In some embodiments, a protective layer (and/or composition for forming the protective layer) comprises a ceramic, such as an ionically conductive ceramic (e.g., a ceramic conductive to lithium ions). In some embodiments, the ceramic may comprise an alkali metal carbonate (e.g., sodium carbonate, potassium carbonate, rubidium carbonate, cesium carbonate, and/or lithium carbonate) and/or an alkaline earth metal carbonate (e.g., calcium carbonate, strontium carbonate, beryllium carbonate, barium carbonate, magnesium carbonate, and/or radium carbonate). As described herein, the ceramic may coat at least a portion of the particles in the protective layer.

In some embodiments, the protective layer (and/or the composition of the materials, such as the particles, for forming the protective layer) comprises one or more ceramics. For example, in some embodiments, the protective layer (and/or composition of materials for forming the protective layer) comprises at least two ceramics (e.g., at least two alkali metal carbonates). The at least two ceramics may be present in any suitable atomic ratio with respect to each other. For instance, in some embodiments, a first and a second ceramic material (e.g., a first and second alkali metal carbonate) are present in the protective layer (and/or composition for forming the protective layer) at an atomic ratio of greater than or equal to 1:10, greater than or equal to 1:8, greater than or equal to 1:4, greater than or equal to 1:2, greater than or equal to 1:1, greater than or equal to 2:1, greater or equal to 4:1, or greater than or equal to 8:1. In some embodiments, the first and second ceramic materials (e.g., first and second alkali metal carbonates) are present in the protective layer (and/or composition for forming the protective layer) at an atomic ratio of less than or equal to 10:1, less than or equal to 8:1, less than or equal to 4:1, less than or equal to 2:1, less than or equal to 1:1, less than or equal to 1:2, less than or equal to 1:4, or less than or equal to 1:8. Combinations of the above-referenced ranges are also possible (e.g., greater than or equal 1:1 or less than or equal to 10:1). Other ranges are also possible. In some embodiments, the ceramic (e.g., first and/or second ceramic material) comprises potassium carbonate (e.g., K₂CO₃) and/or lithium carbonate (e.g., Li₂CO₃). In one particular set of embodiments, the atomic ratio of the potassium carbonate in the protective layer to the lithium carbonate in the protective layer may be in one or more of the ranges provided above.

In some embodiments, one or more ceramics is and/or are present in the protective layer (and/or composition for forming the protective layer) at an amount of between 60 wt % and 98 wt % (versus the total weight of the protective layer). In some embodiments, one or more ceramics is and/or are present in the protective layer (and/or composition for forming the protective layer) at a concentration of greater than or equal to 60 wt %, greater than or equal to 70 wt %, greater than or equal to 80 wt %, greater than or equal to 90 wt %, or greater than or equal to 95 wt %. In some embodiments, the ceramic(s) is and/or are is present in the protective layer (and/or composition for forming the protective layer) at a concentration of less than or equal to 98 wt %, less than or equal to 95 wt %, less than or equal to 90 wt %, less than or equal to 80 wt %, or less than or equal to 70 wt %. Combinations of the above-referenced ranges are also possible (e.g., greater than or equal to 60 wt % and less than or equal to 98 wt %). Other ranges are also possible. Each of the one or more ceramics may coat at least a portion of the particles in the protective layer.

When a protective layer (and/or composition for forming the protective layer) comprises two or more ceramics, each ceramic present may independently be present in one or more of the amounts provided above. Additionally, all of the ceramics in a protective layer may together make up an amount of the protective layer in one or more of the ranges described above.

In some embodiments, a protective layer (and/or composition for forming the protective layer) comprises a plurality of ionically insulating particles. Such particles may comprise, consist essentially of, and/or consist of an ionically insulating material. In some embodiments, the ionically insulating particles may be non-conductive (e.g., non-conductive to ions, such as lithium ions). In some embodiments, the ionically insulating particles may comprise a plurality of particles such as nanoparticles and/or microparticles. For instance, the ionically insulating particles may comprise aluminum oxide particles and/or silica particles.

The plurality of ionically insulating particles may be of any suitable size. In some embodiments, the average cross-sectional diameter of the ionically insulating particles (e.g., excluding any ceramic coating, prior to ceramic coating) is greater than or equal to 0.2 μm, greater than or equal to 0.5 μm, greater than or equal to 0.75 μm, greater than or equal to 1 μm, greater than or equal to 2 μm, greater than or equal to 4 μm, greater than or equal to 5 μm, greater than or equal to 6 μm, or greater than or equal to 8 μm. In some embodiments, the average cross-sectional diameter of the ionically insulating particles (e.g., excluding any ceramic coating, prior to ceramic coating) is less than or equal to 10 μm, less than or equal to 8 μm, less than or equal to 6 μm, less than or equal to 5 μm, less than or equal to 4 μm, less than or equal to 2 μm, less than or equal to 1 μm, less than or equal to 0.75 μm, or less than or equal to 0.5 μm. Combinations of the above-referenced ranges are also possible (e.g., greater than or equal to 0.2 μm and less than or equal to 10 μm, or greater than or equal to 0.5 μm and less than or equal to 5 μm). Other ranges are also possible. The average cross-sectional diameter of the ionically insulating particles may be determined using microscopy techniques, such as SEM. The average cross-sectional diameter of any particular particle may be determined by calculating the diameter of a sphere having the same volume as the particle. The average cross-sectional diameter of a plurality of particles may be determined by averaging the average cross-sectional diameters for the particles making up the plurality.

In some embodiments, the plurality of ionically insulating particles has a surface area of between 1 m²/g and 100 m²/g (e.g., at the interface with any ceramic coating, prior to ceramic coating). In some embodiments, the surface area of the ionically insulating particles (e.g., at the interface with any ceramic coating, prior to ceramic coating) is greater than or equal to 1 m²/g, greater than or equal to 5 m²/g, greater or equal to 10 m²/g, greater than or equal to 20 m²/g, greater than or equal to 40 m²/g, greater than or equal to 60 m²/g, or greater than or equal to 80 m²/g. In some embodiments, the surface area of the ionically insulating particles (e.g., at the interface with any ceramic coating, prior to ceramic coating) is less than or equal to 100 m²/g, less than or equal to 60 m²/g, less than or equal to 80 m²/g, less than or equal to 40 m²/g, less than or equal to 20 m²/g, less than or equal to 10 m²/g, or less than or equal to 5 m²/g. Combinations of the above-referenced ranges are also possible (e.g., greater than or equal to 1 m²/g and less than or equal to 100 m²/g). Other ranges are also possible. The surface area of a plurality of ionically insulating particles may be determined by performing a BET measurement.

The ionically insulating particles (e.g., the plurality of ionically insulating particles) may include pores and may therefore be porous and/or comprise a porous region. The pores of an ionically insulating particle may be of any of a variety of suitable sizes (e.g., measured as an average cross-sectional pore diameter). In some embodiments, the pores in the ionically insulating particles have an average cross-sectional diameter of greater than or equal to 0.1 μm, greater than or equal to 0.2 μm, greater than or equal to 0.5 μm, greater than or equal to 0.75 μm, greater than or equal to 1 μm, greater than or equal to 1.5 μm, greater than or equal to 2 μm, greater than or equal to 2.5 μm, greater than or equal to 3 μm, greater than or equal to 3.5 μm, greater than or equal to 4 μm, or greater than or equal to 4.5 μm. In some embodiments, the pores in the ionically insulating particles have an average cross-sectional diameter of less than or equal to 5 μm, less than or equal to 4.5 μm, less than or equal to 4 μm, less than or equal to 3.5 μm, less than or equal to 3 μm, less than or equal to 2.5 μm, less than or equal to 2 μm, less than or equal to 1.5 μm, less than or equal to 1 μm, less than or equal to 0.075 μm, less than or equal to 0.5 μm, or less than or equal to 0.2 μm. Combinations of the above-referenced ranges are also possible (e.g., greater than or equal to 0.1 μm and less than or equal to 5 μm). Other ranges are also possible.

The cross-sectional diameter of a pore and the average cross-sectional pore diameter of an ionically insulating particle can be measured via mercury intrusion porosimetry using ASTM Standard Test D4284-07.

In some embodiments, the plurality of ionically insulating particles is present in the protective layer (e.g., as a component in one or more particles present in a protective layer, as a component in the protective layer coated by a ceramic) at an amount of between 2 wt % and 40 wt % (versus the total weight of the protective layer). In some embodiments, the ionically insulating particles are present at an amount of greater than or equal to 2 wt %, greater than or equal to 4 wt %, greater than or equal to 8 wt %, greater than or equal to 10 wt %, greater than or equal to 15 wt %, greater than or equal to 20 wt %, greater than or equal to 25 wt %, greater than or equal to 30 wt % or greater than or equal to 35 wt %. In some embodiments, the ionically insulating particles are present at an amount of less than or equal to 40 wt %, less than or equal to 30 wt %, less than or equal to 20 wt %, less than or equal to 10 wt %, less than or equal to 8 wt %, or less than or equal to 4 wt %. Combinations of the above-referenced ranges are also possible (e.g., greater than or equal to 2 wt % and less than or equal to 20 wt %). Other ranges are also possible.

In some embodiments, the ceramic (e.g., Li₂CO₃) and/or ionically insulating particles (e.g., aluminum oxide, Al₂O₃) are insoluble in an electrolyte to be used with the article (e.g., electrochemical cell). Electrolytes, described elsewhere herein, may provide ionic conductivity between, for example, an anode and cathode of an electrochemical cell.

As described herein, in some embodiments, the protective layer (and/or a composition of materials for forming the protective layer) comprises a mixture comprising a ceramic (e.g., Li₂CO₃) and a plurality of ionically insulating particles (e.g., Al₂O₃), with each ionically insulating particle comprising a surface. In some embodiments, the ceramic coats at least a portion of the surface of the ionically insulating particles. As discussed elsewhere herein, the method of making the mixture may comprise heating the ceramic above its melting point. This may allow the ceramic to coat (e.g., as a molten solid) all or portions of the outer surface of the ionically insulating particles within the mixture. Without wishing to be bound by any particular theory, it is believed that upon cooling the mixture, the underlying surface (e.g., that is ionically insulating) of the ceramic-coated particles physically distorts the crystal lattice structure of the ceramic coating, which introduces strain into the structure and increases the ionic conductivity of the protective layer, e.g., compared to the unstrained ceramic.

In some embodiments, a protective layer (and/or composition for forming the protective layer) comprises a material that forms from a reaction between an ionically insulating particle and a ceramic. This reaction may occur upon the application of heat to a mixture comprising these components, such as during the process described above with respect to FIG. 5. In some embodiments, the material that forms from a reaction between an ionically insulating particle and a ceramic comprises the incorporation of the ceramic into the lattice structure of a material making up the ionically insulating particle (and/or vice versa) to form a new material (e.g., a new ceramic) including atoms originating from both the ceramic and the ionically insulating particle.

As one example, a protective layer (and/or a composition for forming the protective layer) comprises an aluminate, such as lithium aluminate. Without wishing to be bound by any particular theory, it is believed that if an alkali metal and/or an alkaline earth metal ceramic (e.g., Li₂CO₃) is melted in the presence of aluminum oxide particles (e.g., Al₂O₃), the alkali metal and/or an alkaline earth metal (e.g., Li ion) may become incorporated into the lattice structure of the aluminum oxide to yield the respective aluminate. For example, melting a mixture comprising a lithium carbonate ceramic and aluminum oxide particles may produce at least some lithium aluminate (e.g., in the particles). In some embodiments, a particle comprising an aluminate (e.g., a lithium aluminate) may also have a coating of ceramic on at least a portion of its surface. In some embodiments, the aluminate particle may strain the crystal lattice of the structure of the ceramic coating its surface.

Some aspects of the present disclosure relate to methods of preparing a protective layer and/or a composition to be employed in a protective layer. As described above, in some embodiments, the method comprises preparing a mixture comprising a ceramic and a plurality of ionically insulating particles. The preparation may comprise milling a mixture comprising an alkali metal carbonate salt and/or alkaline earth metal carbonate salt and a plurality of ionically insulating particles. In some embodiments, the mixture comprises at least one alkali metal carbonate salt (e.g., Li₂CO₃) and aluminum oxide (e.g., Al₂O₃). In some embodiments, the mixture comprises at least two alkali metal carbonate salts and aluminum oxide.

Preparing the mixture may comprise milling and/or sieving the mixture to form particles and/or a fine powder. The milled and/or sieved mixture may have an average cross-sectional diameter of between 0.1 μm and 10 μm. For example, in some embodiments, the average cross-sectional diameter of the particles is greater than or equal to 0.1 μm, greater than or equal to 0.2 μm, greater than or equal to 0.5 μm, greater than or equal to 0.75 μm, greater than or equal to 1 μm, greater than or equal to 2 μm, greater than or equal to 4 μm, or greater than or equal to 8 μm. In some embodiments, particles may have an average cross-sectional diameter of less than or equal to 10 μm, less than or equal to 8 μm, less than or equal to 4 μm, less than or equal to 2 μm, less than or equal to 1 μm, less than or equal to 0.75 μm, less than or equal to 0.5 μm, or less than or equal to 0.2 μm. Combinations of the above-referenced ranges are also possible (e.g., greater than or equal to 0.1 μm and less than or equal to 10 μm). Other ranges are also possible. The average cross-sectional diameter of the particles may be determined as described elsewhere herein for the ionically insulating particles.

In some embodiments, the mixture (e.g., a milled and/or sieved mixture) is pressed into a mold (e.g., ceramic or metal), placed into a furnace, and heated to a temperature above the melting temperature of the ceramic (e.g., melting temperature of Li₂CO₃ is about 723° C., the melting temperature of a Li₂CO₃ and K₂CO₃ eutectic is about 503° C.) but below the melting temperature of the ionically insulating material (e.g., melting temperature of aluminum oxide is about 2072° C.). The mold may have any suitable cross-sectional shape such as, for example, circular, elliptical, polygonal (e.g., rectangular, triangular, etc.), irregular, and the like. In some embodiments, the mold is a crucible.

In some embodiments, the furnace has an initial temperature (i.e., a temperature at the point in time at which the mixture is introduced thereinto) of greater than or equal to 500° C., greater than or equal to 525° C., greater than or equal to 550° C., or greater than or equal to 575° C. In some embodiments, the furnace has an initial temperature of less than or equal to 600° C., less than or equal to 575° C., less than or equal to 550° C., or less than or equal to 525° C. Combinations of the above-referenced ranges are also possible (e.g., greater than or equal to 500° C. and less than or equal to 600)° ° C. Other ranges are also possible.

In some embodiments, the temperature of the furnace is raised to a second temperature that is above the melting point of the ceramic but below the melting point of the ionically insulating material. For instance, in some embodiments, the second temperature is greater than or equal to 575° C., greater than or equal to 580° ° C., or greater than or equal to 590° C. In some embodiments, the second temperature is less than or equal to 600° C., less than or equal to 590° C., or less than or equal to 580° C. Combinations of the above-referenced ranges are also possible (e.g., greater than or equal to 575° C. and less than or equal to 600° C.). Other ranges are also possible.

In some embodiments, the furnace is ramped from the first temperature to the second temperature at a rate of between 5° C./min and 15° C./min. In some embodiments, the furnace is ramped at a rate of greater than or equal to 5° C./min, greater than or equal to 7° C./min, greater than or equal to 9° C./min, greater than or equal to 11° C./min, or greater than or equal to 13° C./min. In some embodiments, the furnace is ramped at a rate of less than or equal to 15° C./min, less than or equal to 13° C./min, less than or equal to 11° C./min, less than or equal to 9° C./min, or less than or equal to 7° C./min. Combinations of the above-referenced ranges are also possible (e.g., greater than or equal to 5° C./min and less than or equal to 15° C./min). Other ranges are also possible.

In some embodiments, the furnace is held at the second temperature until the ceramic becomes a molten ceramic and the molten ceramic wets the surfaces of the ionically insulating particles. When the molten ceramic wets the surfaces of the ionically insulating particles, it may spread on their surfaces, cover some or all of their surfaces, and/or adhere thereto.

In some embodiments, the mixture is removed from the furnace. Removal may occur after the molten ceramic has wet the surface of the ionically insulating particles and/or while the molten ceramic is wetting the surface of the ionically insulating particles. In some embodiments, the mixture is subsequently cooled to room temperature. After cooling, according to some embodiments, the ceramic coats at least a portion of the surfaces of the ionically insulating particles. Additionally, the ionically insulating particles coated with the ceramic may induce strain in the crystal lattice structure of the ceramic coating their surface. In some embodiments, the cooling rate may affect the crystal structure of the ceramic. For example, in some embodiments, rapid cooling further increases the strain in the ceramic crystal lattice structure; whereas, in other embodiments, slow cooling decreases the strain in the ceramic crystal lattice structure.

The rate and/or rates at which the mixture is cooled may be selected as desired. In some embodiments, the mixture is cooled from a maximum temperature (e.g., a second temperature) to a temperature at which it solidifies (e.g., 450° C.) over a period of time of greater than or equal to 0 seconds, greater than or equal to 1 second, greater than or equal to 2 seconds, greater than or equal to 5 seconds, greater than or equal to 7.5 seconds, greater than or equal to 10 seconds, greater than or equal to 15 seconds, greater than or equal to 20 seconds, greater than or equal to seconds, greater than or equal to 30 seconds, greater than or equal to 35 seconds, greater than or equal to 40 seconds, greater than or equal to 45 seconds, greater than or equal to 50 seconds, or greater than or equal to 55 seconds. In some embodiments, the mixture is cooled from a maximum temperature to a temperature at which it solidifies over a period of time of less than or equal to 60 seconds, less than or equal to 55 seconds, less than or equal to 50 seconds, less than or equal to 45 seconds, less than or equal to 40 seconds, less than or equal to 35 seconds, less than or equal to 30 seconds, less than or equal to 25 seconds, less than or equal to 20 seconds, less than or equal to 15 seconds, less than or equal to 10 seconds, less than or equal to 7.5 seconds, less than or equal to 5 seconds, less than or equal to 2 seconds, or less than or equal to 1 second. Combinations of the above-referenced ranges are also possible (e.g., greater than or equal to 0 seconds and less than or equal to 60 seconds). Other ranges are also possible.

In some embodiments, a mixture is cooled from a temperature at which it solidifies to 100° C. over a period of time of greater than or equal to 0 minutes, greater than or equal to 0.1 minute, greater than or equal to 0.2 minutes, greater than or equal to 0.5 minutes, greater than or equal to 0.75 minutes, greater than or equal to 1 minute, greater than or equal to 2 minutes, greater than or equal to 5 minutes, or greater than or equal to 7.5 minutes. In some embodiments, the mixture is cooled from a temperature at which it solidifies to 100° C. over a period of time of less than or equal to 10 minutes, less than or equal to 7.5 minutes, less than or equal to 5 minutes, less than or equal to 2 minutes, less than or equal to 1 minute, less than or equal to 0.75 minutes, less than or equal to 0.5 minutes, less than or equal to 0.2 minutes, or less than or equal to 0.1 minute. Combinations of the above-referenced ranges are also possible (e.g., greater than or equal to 0 minutes and less than or equal to 10 minutes). Other ranges are also possible.

In some embodiments, the mixture is cooled from 100° C. to room temperature over a period of time of greater than or equal to 0 minutes, greater than or equal to 1 minute, greater than or equal to 2 minutes, greater than or equal to 5 minutes, greater than or equal to 7.5 minutes, greater than or equal to 10 minutes, greater than or equal to 12.5 minutes, greater than or equal to 15 minutes, greater than or equal to 17.5 minutes, greater than or equal to 20 minutes, greater than or equal to 22.5 minutes, greater than or equal to 25 minutes, or greater than or equal to 27.5 minutes. In some embodiments, the mixture is cooled from 100° C. to room temperature over a period of time of less than or equal to 30 minutes, less than or equal to 27.5 minutes, less than or equal to 25 minutes, less than or equal to 22.5 minutes, less than or equal to 20 minutes, less than or equal to 17.5 minutes, less than or equal to 15 minutes, less than or equal to 12.5 minutes, less than or equal to 10 minutes, less than or equal to 7.5 minutes, less than or equal to 5 minutes, less than or equal to 2 minutes, or less than or equal to 1 minute. Combinations of the above-referenced ranges are also possible (e.g., greater than or equal to 0 minutes and less than or equal to 30 minutes). Other ranges are also possible.

In some embodiments, the cooled mixture is milled into a fine powder until the average cross-sectional diameter is between 0.2 μm and 10 μm. A variety of suitable techniques may be used to reduce the particle size. Examples include, but are not limited to, air classifying milling, pin milling, hammer milling, jet milling, ball milling, and techniques that may be performed by hand (e.g., with a mortar and pestle, with a sieve). In some embodiments, the average cross-sectional diameter of the particles making up the fine powder is greater than or equal to 0.1 μm, greater than or equal to 0.2 μm, greater than or equal to 0.5 μm, greater than or equal to 0.75 μm, greater than or equal to 1 μm, greater than or equal to 2 μm, greater than or equal to 4 μm, or greater than or equal to 8 μm. In some embodiments, the particles have an average cross-sectional diameter of less than or equal to 10 μm, less than or equal to 8 μm, less than or equal to 4 μm, less than or equal to 2 μm, less than or equal to 1 μm, less than or equal to 0.75 μm, less than or equal to 0.5 μm, or less than or equal to 0.2 μm. Combinations of the above-referenced ranges are also possible (e.g., greater than or equal to 0.1 μm and less than or equal to 10 μm). Other ranges are also possible. The average cross-sectional diameter of the particles may be determined as described elsewhere herein for the ionically insulating particles.

In some embodiments, the mixture (e.g., after having formed the molten ceramic and performed the subsequent cooling step) has a powder conductivity (e.g., a powder ionic conductivity, such as a powder ionic conductivity to lithium ions) that is greater than the conductivity of the ceramic alone, the ionically insulating material alone, and/or a mixture of the ceramic and the ionically insulating material that has not undergone the molten step. In some embodiments, the powder conductivity is between 1.1× and 5× greater than the conductivity of the ceramic and/or the ionically insulating material. For example, the powder conductivity of the mixture may be greater than or equal to 1.1×, greater than or equal to 1.5×, greater than or equal to 2×, greater than or equal to 2.5×, greater than or equal to 3×, greater than or equal to 3.5×, greater than or equal to 4×, or greater than or equal to 4.5× the conductivity of the ceramic and/or the ionically insulating material. In some embodiments, the powder conductivity of the mixture is less than or equal to 5×, less than or equal to 4.5×, less than or equal to 4×, less than or equal to 3.5×, less than or equal to 3×, less than or equal to 2.5×, less than or equal to 2×, or less than or equal to 1.5× the conductivity of the ceramic and/or the ionically insulating material. Powder conductivity may be measured at room temperature (e.g., 25)° ° C., for example, using a conductivity bridge (i.e., an impedance measuring circuit) operating at 1 KHz in the absence of an electrolyte and/or solvent (i.e., for a dry protective layer and/or deposited layer).

In some embodiments, the fine powder is deposited onto a layer comprising lithium (e.g., lithium metal). For example, the layer may be an electroactive layer (e.g., an electrode and/or a component of an electrode). In some embodiments, depositing the fine powder onto the layer comprising lithium comprises performing a process that does not chemically change the fine powder, such as a physical deposition process. Any suitable physical deposition method known in the art may be used to deposit the coating onto the layer. Examples include, but are not limited to, aerosol deposition, RF sputtering (e.g., ion beam-assisted RF sputtering), vacuum thermal evaporation, electron beam evaporation, laser beam evaporation, arc evaporation, and/or molecular beam epitaxy.

In some embodiments, depositing the fine powder onto the layer comprising lithium (e.g., lithium anode) comprises performing aerosol deposition. Aerosol deposition processes generally comprise depositing (e.g., spraying) particles (e.g., the particles described herein, inorganic particles) at a relatively high velocity on a surface. Aerosol deposition may result in the collision and/or elastic deformation of at least some of the particles. For example, in some embodiments, the particles are deposited on the first layer (e.g., the electroactive layer) at a relative high velocity such that at least a portion of the plurality of particles fuse (e.g., forming a second layer, such as a protective layer, on the first layer). The velocity required for particle fusion may depend on factors such as the material composition of the particles, the size of the particles, the Young's elastic modulus of the particles, and/or the yield strength of the particles or material forming the particles.

In some embodiments, a process described herein for forming a protective layer can be carried out such that the bulk properties of the precursor materials (e.g., particles comprising a ceramic and/or an ionically insulating material) are maintained in the resulting layer (e.g., crystallinity, ion conductivity). In some cases, the use of aerosol deposition permits the deposition of particles formed of certain materials (e.g., ceramics) not feasible using other deposition techniques (e.g., vacuum deposition). For example, vacuum deposition (e.g., such as sputtering, e-beam evaporation) typically involves relatively high temperatures that would cause some ceramic materials to lose their bulk properties (e.g., crystallinity and/or ion conductivity) upon deposition. Vacuum deposition of certain materials can also leads to cracking of the resulting layer because such materials may have desirable mechanical properties in the crystalline state which are lost during vacuum deposition (e.g., as amorphous films) resulting in crack formation and/or mechanical stresses formed in the layer (e.g., as a result of strength and/or thermal characteristic mismatch between the substrate and the layer). Vacuum deposition may also not be suitable for depositing particles that have been pre-formed. In some embodiments, tempering of the material may not be possible after vacuum deposition for at least the aforementioned reasons. Since aerosol deposition can be carried out at relatively lower temperatures, e.g., compared to certain vacuum deposition techniques, certain materials (e.g., crystalline materials) that are typically incompatible with forming an-ion conductive layer/protective layer can now be used. Additionally, particles may be formed and then deposited by aerosol deposition.

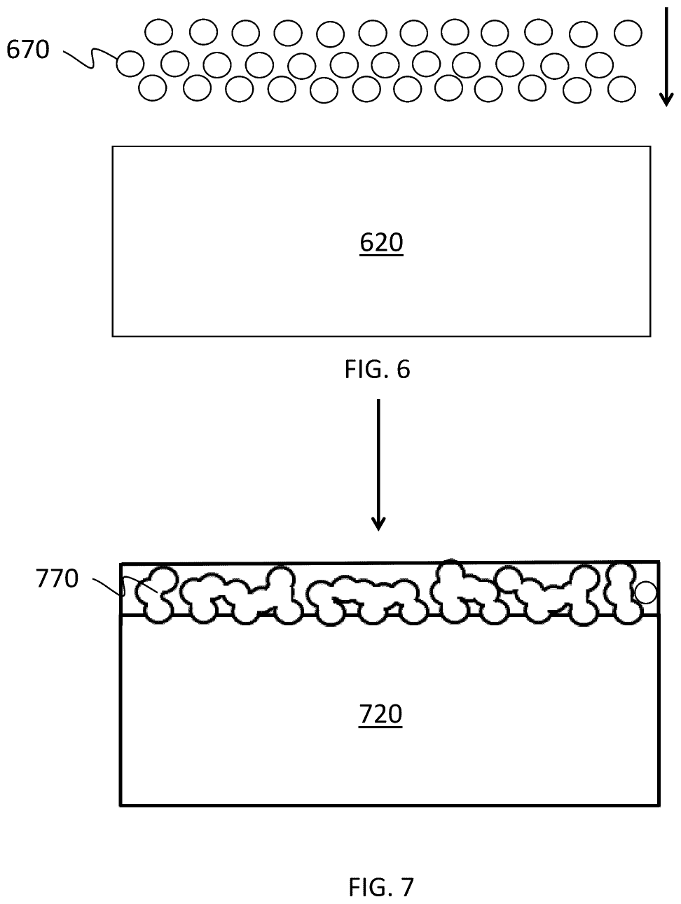

In one exemplary method, and referring to FIG. 6, forming a protective layer may involve providing an electroactive layer as a substrate for the formation of the protective layer. The particles 670 (e.g., inorganic particles) may be deposited by any suitable method (e.g., aerosol deposition). Referring now to FIG. 7, the particles 770 may be deposited (as indicated by the arrow) onto the electroactive layer 720. The deposition of the particles may cause the particles to be at least partially embedded within the electroactive layer. In some embodiments, the particles are deposited at a sufficient velocity such that at least some of the particles come into direct contact with and/or are at least partially embedded within the electroactive layer. In some embodiments, the particles are deposited at a sufficient velocity such that at least some of the plurality of particles are at least partially embedded within the electroactive layer and at least some of the particles are fused (FIG. 7).

Advantageously, in some embodiments, the deposition of particles on the electroactive layer as described herein (e.g., to form a protective layer) breaks up any passivation layer that may be present on the surface of the electroactive layer, which may result in increased direct contact between the deposited protective layer and a surface of the electroactive layer. By way of example, in some embodiments, a passivation layer, e.g., comprising lithium chloride, may be present on the surface of the electroactive layer (e.g., comprising lithium metal) and, during deposition of particles on the electroactive layer as described herein, at least a portion of the passivation layer may be removed such that at least a portion of the deposited particles are in direct contact with the electroactive layer.

In some embodiments, particles comprising an ionically insulating material and/or a ceramic are codeposited with polymeric particles (e.g., comprising a non-ionically conductive polymeric material and/or an ion-conductive polymeric material). In an exemplary embodiment, such particles are codeposited with particles comprising polyethylene.

In some aspects, polymeric particles make up an amount of the particles being deposited of at least 5 wt %, at least 10 wt %, at least 20 wt %, or at least 25 wt % of the all of the deposited particles. In certain aspects, the polymeric make up an amount of the particles being deposited of less than or equal to 30 wt %, less than or equal to 25 wt %, less than or equal to 20 wt %, less than or equal to 15 wt %, or less than or equal to 10 wt % of the all of the deposited particles. Combinations of the above referenced ranges are also possible (e.g., between 5 wt % and 30 wt %). Other ranges are also possible. In some cases, no polymeric particles are deposited.

In some embodiments, polymeric particles may be deposited on an electroactive layer prior to deposition of other particles (e.g., particles comprising an ionically insulating material and/or a ceramic). In certain aspects, the other particles may be deposited after and onto/into the polymeric particles such that at least a portion of the other particles fuse.

In some aspects, a gradient in the density of the particles comprising an ionically insulating material and/or a ceramic across the thickness of the layer may be formed. For instance, particles comprising an ionically insulating material and/or a ceramic may be deposited onto polymeric particles. The resulting structure may be a composite of the particles comprising an ionically insulating material and/or a ceramic and the polymeric particles, with the density of the particles comprising an ionically insulating material and/or a ceramic increasing across at least a portion (or substantially all of) the thickness of the resulting structure. Such a structure may be formed, in some aspects, by increasing the velocity of the particles comprising an ionically insulating material and/or a ceramic gradually throughout deposition. In some instances, the deposition occurs such that at least a portion of the particles comprising an ionically insulating material and/or a ceramic fuse. For instance, the particles comprising an ionically insulating material and/or a ceramic at the outer surface of the resulting structure may be substantially fused, while the particles comprising an ionically insulating material and/or a ceramic adjacent the first surface may remain substantially unfused, partially fused, or fused to a lesser extent compared to that at the outer surface. In some embodiments, the reverse gradient can be formed.

Any suitable polymeric material can be included in polymeric particles. In some aspects, the polymeric material may include or consist essentially of one or more polymeric materials. The polymeric material may, in some aspects, be a monomer, a mixture of copolymers, block copolymers, or a combination of two or more polymers that are in an interpenetrating network or semi-interpenetrating network. In some aspects, the polymeric material may comprise a filler and/or solid additive. The filler and/or solid additive may add strength, flexibility, and/or improved adhesion properties to the polymer. In some aspects, the polymer may comprise a plasticizer or other additives, including solid phase change materials. Addition of plasticizers may increase flexibility of the polymer and improve thixotropic properties. Addition of solid phase change materials may result in addition of materials that melt at elevated temperatures and thereby act as a heat sink and prevent thermal runaway.

In some aspects, a polymeric material may be selected to be flexible. Nano-hardness studies may be conducted to measure creep and/or hardness and thereby assess the flexibility and/or brittleness of a polymeric material. In certain cases, the polymeric material may be selected to be thermally stable above 100° C., 150° C., 200° C., 250° C., 300° C., 350° C., or 400° C. Thermal stability may be assessed by differential scanning calorimetry (DSC). Non-limiting examples of polymeric materials that may exhibit thermal stability at elevated temperatures include polysiloxanes, polycyanurates, and polyisocyanurates.

The polymeric material may, in certain cases, be selected to be substantially inert to the electrolyte solution and/or to Li polysulfide attack. A means of determining the stability of a polymeric material in an electrolyte solution includes exposing a small sample of the polymeric material to vapors of an electrolyte solvent, or to the electrolyte solvent itself. Examples of polymeric materials that may be stable in an electrolyte solution include, but are not limited to, polyurethanes and polysiloxanes. Additional tests that may be conducted on polymeric materials to examine various characteristics include Fourier transform infrared spectroscopy (FTIR) to confirm that a polymeric material is cured or cross-linked, scanning electron microscopy with energy dispersive x-ray spectroscopy (SEM-EDS) to determine whether a polymeric material has cracks. Such test and other tests can also be used to determine whether a protective layer comprises discrete layers, interpenetrating networks, or semi-interpenetrating networks. Profilometry can be used to assess how rough the surface of a polymeric material is.

Other classes of polymeric materials that may be suitable for use in polymeric particles include, but are not limited to, polyamines (e.g., poly(ethylene imine) and polypropylene imine (PPI)); polyamides (e.g., polyamide (Nylon), poly(e-caprolactam) (Nylon 6), poly(hexamethylene adipamide) (Nylon 66)), polyimides (e.g., polyimide, polynitrile, and poly(pyromellitimide-1,4-diphenyl ether) (Kapton)); vinyl polymers (e.g., polyacrylamides, poly(acrylates), poly(methacrylates), poly(2-vinyl pyridine), poly(N-vinylpyrrolidone), poly(methylcyanoacrylate), poly(vinyl acetate), poly (vinyl alcohol), poly(vinyl chloride), poly(vinyl fluoride), poly(2-vinyl pyridine), vinyl polymer, polychlorotrifluoro ethylene, and poly(isohexylcynaoacrylate)); polyacetals; polyolefins (e.g., poly(butene-1), poly(n-pentene-2), polyethylene, polypropylene, polytetrafluoroethylene); polyesters (e.g., polycarbonate, polybutylene terephthalate, polyhydroxybutyrate); polyethers (poly(ethylene oxide) (PEO), poly(propylene oxide) (PPO), poly(tetramethylene oxide) (PTMO)); vinylidene polymers (e.g., polyisobutylene, poly(methyl styrene), poly(methylmethacrylate) (PMMA), poly(vinylidenc chloride), and poly(vinylidene fluoride)); polyaramides (e.g., poly(imino-1,3-phenylene iminoisophthaloyl) and poly(imino-1,4-phenylene iminoterephthaloyl)); polyheteroaromatic compounds (e.g., polybenzimidazole (PBI), polybenzobisoxazole (PBO) and polybenzobisthiazole (PBT)); polyheterocyclic compounds (e.g., polypyrrole); polyurethanes; phenolic polymers (e.g., phenol-formaldehyde); polyalkynes (e.g., polyacetylene); polydienes (e.g., 1,2-polybutadiene, cis or trans-1,4-polybutadienc); polysiloxanes (e.g., poly(dimethylsiloxane) (PDMS), poly(diethylsiloxane) (PDES), polydiphenylsiloxane (PDPS), and polymethylphenylsiloxane (PMPS)); and inorganic polymers (e.g., polyphosphazene, polyphosphonate, polysilanes, polysilazanes). In some aspects, the polymeric material may be selected from the group consisting of polyvinyl alcohol, polyisobutylene, epoxy, polyethylene, polypropylene, polytetrafluoroethylene, and combinations thereof.

As described herein, in some aspects polymeric particles comprise a polymeric material is substantially non-ionically conductive. However, in embodiments in which it is desirable for the polymeric particles to comprise a polymeric material that is ionically conductive (e.g., particles comprising such ionically conductive polymeric materials), the polymeric materials listed above and herein may further comprise salts, for example, lithium salts (e.g., LiSCN, LiBr, LiI, LiCIO₄, LiAsF₆, LISO₃CF₃, LiSO₃CH₃, LiBF₄, LiB(Ph)₄, LiPF₆, LIC(SO₂CF₃)₃, and LIN(SO₂CF₃)₂), to enhance ionic conductivity. Salts may be added to the material in a range of, e.g., 0 to 50 mol %. In certain aspects, salts are included in at least 5 mol %, at least 10 mol %, at least 20 mol %, at least 30 mol %, at least 40 mol %, or at least 50 mol % of the material. In certain aspects, additional salts are less than or equal to 50 mol %, less than or equal to 40 mol %, less than or equal to 30 mol %, less than or equal to 20 mol %, or less than or equal to 10 mol % of the material. Combinations of the above-noted ranges are also possible. Other values of mol % are also possible.

In certain aspects, the average ionic conductivity of the polymeric material may be less than or equal to 10-3 S/cm, less than or equal to 104 S/cm, less than or equal to 10-5 S/cm, less than or equal to 106 S/cm, or less than or equal to 10-7 S/cm. In some aspects, the average ionic conductivity of the polymeric material is at least 10-8 S/cm, at least 10-7 S/cm, at least 106 S/cm, at least 105 S/cm, at least 104 S/cm, or at least 10-3 S/cm. Combinations of the above-referenced ranges are also possible (e.g., an average ionic conductivity in the electrolyte of at least 10-8 S/cm and less than or equal to 106 S/cm). Conductivity may be measured at room temperature (e.g., 25° C.).

In some aspects, the polymeric material may be substantially non-ionically conductive and substantially non-electrically conductive. For example, non-electrically conductive materials (e.g., electrically insulating materials) such as those described herein can be used. In other aspects, the polymeric material may be ionically conductive but substantially non-electrically conductive. Examples of such polymeric materials include non-electrically conductive materials (e.g., electrically insulating materials) that are doped with lithium salts, such as acrylate, polyethylene oxide, silicones, and polyvinyl chlorides.

In some aspects, the polymeric material is substantially non-swellable in an electrolyte solvent to be used in an electrochemical cell including such a protective layer and/or resulting deposited layer. For instance, the polymeric material and/or layer may experience a volume change of less than 10%, less than 8%, less than 6%, less than 5%, less than 4%, less than 2%, or less than 1% when in contact with an electrolyte solvent (including any salts or additives present) to be used in an electrochemical cell including such a protective layer for at least 24 hours. In some aspects, the polymeric material and/or layer may increase in volume (i.e., swell) in the presence of the liquid electrolyte by at least 0.01 vol %, at least 0.1 vol %, at least 0.2 vol %, at least 0.5 vol %, at least 1 vol %, or at least 2 vol %. Combinations of the above referenced ranges are also possible (e.g., between 0.01 vol % and 5 vol %). Simple screening tests of such polymers can be conducted by placing pieces of polymer in the electrolyte solvent (including any salts or additives present) and measuring the weight or volume change of the polymer pieces before and after a 24 hour period, and determining the percentage change in volume relative to the volume before placement in the solvent.

It may be advantageous, in some aspects, for the polymeric material to comprise or be formed of a material that is chemically stable when in contact with one or more layers of the electrochemical cell (e.g., an electrolyte layer). The polymeric material may be chemically stable if, for example, the material does not react chemically (e.g., form a byproduct) with a component of one or more additional layers of the electrochemical cell in direct contact with the polymeric material. For example, in certain aspects, the polymeric material is chemically stable when in contact with the electroactive material, when in contact with an electrolyte material, and/or when in contact with a polysulfide. In certain aspects, the polymeric material may form a reaction product with the components of the electrode for electrochemical cell (e.g., an electroactive material, an electrolyte material (e.g., a species within the electrolyte), and/or a polysulfide); however, in such aspects, the reaction product does not interfere with the function of a layer including the polymeric material (e.g., the layer remains ionically conductive).

In certain aspects, the polymeric material may be substantially non-cross-linked. However, in other aspects, the polymeric material is cross-linked. In some such aspects, the polymeric material may be cross-linked with a portion of the plurality of particles. For example, in some aspects, a portion of the plurality of particles may be coated with a cross-linking polymer (e.g., bound to the surface of a portion of the plurality of particles). Cross-linking can be achieved by, for example, adding cross-linker to a polymer and performing a cross-linking reaction, e.g., by thermal or photochemical curing, e.g., by irradiation with such as UV/vis irradiation, by y-irradiation, electron beams (e-beams) or by heating (thermal cross-linking). Examples of cross-linkers may include ones selected from molecules with two or more carbon-carbon double bonds, e.g., ones with two or more vinyl groups. Particularly useful cross-linkers are selected from di(meth)acrylates of diols such as glycol, propylene glycol, diethylene glycol, dipropylene glycol, 1,3-propanediol, 1,4-butanediol, triethylene glycol, tetrapropylene glycol, cyclopentadiene dimer, 1,3-divinyl benzene, and 1,4-divinyl benzene. Some suitable cross-linkers may comprise two or more epoxy groups in the molecule, such as, for example, bis-phenol F, bis-phenol A, 1,4-butanediol diglycidyl ether, glycerol propoxylate triglycidyl ether, and the like.

In some aspects, the polymeric material may be in the form of a gel. In some aspects, the polymeric material and/or the resulting deposited layer forms a polymer gel when exposed to a liquid electrolyte. In certain aspects, the polymeric material may swell in the presence of a liquid electrolyte. For example, in some aspects, the polymeric material (e.g., the gel comprising the polymeric material) and/or layer may increase in volume (i.e. swell) in the presence of the liquid electrolyte by at least 20 vol %, at least 30 vol %, at least 40 vol %, at least 50 vol %, at least 60 vol %, at least 70 vol %, at least 80 vol %, or at least 90 vol %. In certain aspects, the polymeric material and/or layer may increase in volume (i.e., swell) in the presence of a liquid electrolyte by less than or equal to 200 vol %, less than or equal to 100 vol %, less than or equal to 80 vol %, less than or equal to 60 vol %, less than or equal to 40 vol %, or less than or equal to 20 vol %. Combinations of the above referenced ranges are also possible (e.g., between 50 vol % and 100 vol %). Simple screening tests of such polymer gels can be conducted by placing pieces of polymer gel in the electrolyte solvent (including any salts or additives present) and measuring the weight or volume change of the gel pieces before and after a 24 hour period, and determining the percentage change in volume relative to the volume before placement in the solvent.

As described herein, in some embodiments, the particles are deposited at a velocity sufficient to cause fusion of at least some of the particles. It should be appreciated, however, that in some embodiments, the particles are deposited at a velocity such that at least some of the particles are not fused. In certain embodiments, the velocity of the particles is at least 150 m/s, at least 200 m/s, at least 300 m/s, at least 400 m/s, or at least 500 m/s, at least 600 m/s, at least 800 m/s, at least 1000 m/s, or at least 1500 m/s. In some embodiments, the velocity is less than or equal to 2000 m/s, less than or equal to 1500 m/s, less than or equal to 1000 m/s, less than or equal to 800 m/s, less than or equal to 600 m/s, less than or equal to 500 m/s, less than or equal to 400 m/s, less than or equal to 300 m/s, or less than or equal to 200 m/s. Combinations of the above-referenced ranges are also possible (e.g., between 150 m/s and 2000 m/s, between 150 m/s and 600 m/s, between 200 m/s and 500 m/s, between 200 m/s and 400 m/s, between 500 m/s and 2000 m/s). Other velocities are also possible. In some embodiments in which more than one particle type is included in a layer, each particle type may be deposited at a velocity in one or more of the above-referenced ranges.

In some embodiments, the deposition method comprises spraying the particles (e.g., via aerosol deposition) on the surface of a layer by pressurizing a carrier gas with the particles. In some embodiments, the pressure of the carrier gas is at least 5 psi, at least 10 psi, at least 20 psi, at least 50 psi, at least 90 psi, at least 100 psi, at least 150 psi, at least 200 psi, at least 250 psi, or at least 300 psi. In certain embodiments, the pressure of the carrier gas is less than or equal to 350 psi, less than or equal to 300 psi, less than or equal to 250 psi, less than or equal to 200 psi, less than or equal to 150 psi, less than or equal to 100 psi, less than or equal to 90 psi, less than or equal to 50 psi, less than or equal to 20 psi, or less than or equal to 10 psi. Combinations of the above-referenced ranges are also possible (e.g., between 5 psi and 350 psi). Other ranges are also possible and those skilled in the art would be capable of selecting the pressure of the carrier gas based upon the teachings of this specification. For example, in some embodiments, the pressure of the carrier gas is such that the velocity of the particles deposited on the first layer is sufficient to fuse at least some of the particles to one another.

In some embodiments, the carrier gas (e.g., the carrier gas with the particles) is heated prior to deposition. In some embodiments, the temperature of the carrier gas is at least 20° C., at least 25° C., at least 30° C., at least 50° C., at least 75° C., at least 100° C., at least 150° C., at least 200° C., at least 300° C., or at least 400° C. In some embodiments, the temperature of the carrier gas is less than or equal to 500° C., less than or equal to 400° C., less than or equal to 300° C., less than or equal to 200° C., less than or equal to 150° C., is less than or equal to 100° C., less than or equal to 75° ° C., less than or equal to 50° C., less than or equal to 30° C. or less than or equal to 20° C. Combinations of the above-referenced ranges are also possible (e.g., between 20° C. and 500° C.) Other ranges are also possible.

In certain embodiments, the particles are deposited under a vacuum environment. For example, in some embodiments, the particles may be deposited on the electroactive layer in a container to which vacuum is applied (e.g., to remove atmospheric resistance to particle flow, to permit high velocity of the particles, and/or to remove contaminants). In some embodiments, the vacuum pressure within the container is at least 0.5 mTorr, at least 1 mTorr, at least 2 mTorr, at least 5 mTorr, at least 10 mTorr, at least 20 mTorr, or at least 50 mTorr. In some embodiments, the vacuum pressure within the container is less than or equal to 100 mTorr, less than or equal to 50 mTorr, less than or equal to 20 mTorr, less than or equal to 10 mTorr, less than or equal to 5 mTorr, less than or equal to 2 mTorr, or less than or equal to 1 mTorr. Combinations of the above-referenced ranges are also possible (e.g., between 0.5 mTorr and 100 mTorr). Other ranges are also possible.

In some embodiments, an electroactive layer may be coated (e.g., pre-coated) prior to deposition of the protective layer. For example, in some embodiments, the electroactive layer may be pre-coated with a polymer, a ceramic (e.g., Al₂O₃, boehmites such as those having the general formula AlO(OH) or derivatives thereof), or combinations thereof. In some embodiments, the coating may comprise a plurality of ceramic particles embedded in a polymer. In some cases, the presence of a coating on the electroactive may permit the deposition of particles having a relatively higher hardness compared particles deposited on an electroactive layer that is not pre-coated, all other factors being equal. Additionally or alternatively, the presence of a coating on the electroactive layer may prevent or reduce undesirable damage to the electroactive layer caused by the deposition of the plurality of particles. In some embodiments, at least a portion of the plurality of particles deposited by a method described herein may be at least partially embedded within the coating of the electroactive layer and/or within the electroactive layer itself.

A coating on the electroactive layer, if present, may be formed of any suitable material. In some embodiments, the material used to form the coating may be formed of a substantially non- or low-lithium ion conductive material (e.g., having a lithium ion conductivity of less than or equal to 10-6 S/cm, less than or equal to 10-7 S/cm, or less than or equal to 10-8 S/cm).

In one particular example, an article for use in an electrochemical cell comprises an electroactive layer comprising a coating, wherein the coating comprises a first material, and a protective layer deposited on the electroactive layer, wherein the second layer comprises a plurality of particles comprising a ceramic and/or an ionically insulating material. The first material has a hardness greater (e.g., at least 10% and less than or equal to 1000% greater) than a hardness of the plurality of particles comprising the ceramic and/or the ionically insulating material. At least a portion of the plurality of particles are fused to one another. The second layer may have an average thickness between 0.1 microns and 5 microns. The coating may have other features and ranges of properties as described herein (e.g., a low lithium ion conductivity, a low weight percentage with respect to the first layer).

A coating on the electroactive layer (e.g., an electroactive layer that is pre-coated) may be formed using any suitable technique. For example, in some embodiments, a vacuum deposition process (e.g., sputtering, CVD, thermal or e-beam evaporation) can be used. In some embodiments, the electroactive layer can be coated by drawing and casting a material from a slurry or gel. In some embodiments, a coating can be formed using a deposition method as described herein (e.g., pre-coating the electroactive layer via deposition of a first plurality of particles), and then a protective layer comprising a second plurality of particles (e.g., comprising a ceramic and/or an ionically insulating material) may be deposited on the coating comprising the first plurality of particles.

The percentage of the total weight of the coating (e.g., pre-coating, if present) compared to the total weight of the electroactive layer on which the coating is deposited may be any suitable value. In some embodiments, the total weight of the coating (e.g., pre-coating) is at least 0.00001%, at least 0.0001%, at least 0.001%, at least 0.01%, at least 0.1%, at least 1%, or at least 10% of the total weight of the electroactive layer. In some embodiments, the total weight of the coating (e.g., pre-coating) is less than or equal to 20%, less than or equal to 10%, less than or equal to 5%, less than or equal to 2%, less than or equal to 1%, less than or equal to 0.1%, less than or equal to 0.01%, less than or equal to 0.001%, or less than or equal to 0.0001% of the total weight of the electroactive layer. Combinations of the above-referenced ranges are also possible. Other ranges are also possible. In some embodiments, the percentage is measured prior to cycling of a cell comprising the components (or prior to the 2nd, 4th, 6th, 8th, or 10th cycle of the cell).

Aspects of the present disclosure relate to electrochemical cells. In some embodiments, an article described herein is positioned in an electrochemical cell. Electrochemical cells may comprise an anode, a cathode, a current collector, a separator, a release layer, electrolyte. The following is a non-limiting discussion of these components.

In some embodiments, an electrochemical cell includes an anode. The anode may comprise the article comprising the electroactive layer and the protective layer.

A variety of chemical species are suitable for inclusion in the electroactive layer of the anode. In some embodiments, the anode electroactive layer includes an anode active electrode species. The anode active electrode species may include an anode active material. In some embodiments, the anode active electrode species comprises lithium. In some embodiments, the lithium is lithium metal, such as a layer of lithium metal. In some embodiments, the lithium metal is a lithium foil. In some embodiments, the lithium is deposited onto a conductive material (e.g., a current collector) or onto a non-conductive material (e.g., a non-conductive release layer). In some embodiments, the lithium metal is vacuum-deposited lithium metal (vdLi). In some embodiments, the lithium metal is a part of a lithium alloy (e.g., a lithium-aluminum alloy and lithium-tin alloy). The lithium may be present as one film or as several films, in some instances separated films. Suitable lithium alloys for use as the first active electrode material as described herein may include alloys of lithium with aluminum, magnesium, silicon, indium, and/or tin.

In some embodiments in which the electroactive layer comprises lithium, the lithium metal/lithium metal alloy may be present during only a portion of charge/discharge cycles. For example, the electrochemical cell may be constructed without any lithium metal/lithium metal alloy on a current collector (e.g., a current collector of the first electrode, an anode current collector), and the lithium metal/lithium metal alloy may subsequently be deposited on the current collector during a charging step. In some embodiments, lithium may be completely depleted after discharging such that lithium is present during only a portion of the charge/discharge cycle.

In some embodiments, the electroactive layer has greater than or equal to 50 wt % lithium, greater than or equal to 75 wt % lithium, greater than or equal to 80 wt % lithium, greater than or equal to 90 wt % lithium, greater than or equal to 95 wt % lithium, greater than or equal to 99 wt % lithium, or more. In some embodiments, the electroactive layer has less than or equal to 99 wt % lithium, less than or equal to 95 wt % lithium, less than or equal to 90 wt % lithium, less than or equal to 80 wt % lithium, less than or equal to 75 wt % lithium, less than or equal to 50 wt % lithium, or less. Combinations of the above-reference ranges are also possible (e.g., greater than or equal to 90 wt % lithium and less than or equal to 99 wt % lithium). Other ranges are possible.

In some embodiments, the electroactive layer has a structure such that lithium ions are liberated therefrom during discharge and lithium ions are integrated thereinto (e.g., intercalated) during charge. In some embodiments, the electroactive layer comprises a lithium intercalation compound (e.g., a compound that is capable of reversibly inserting lithium ions at lattice sites and/or interstitial sites). In some embodiments, the electroactive layer comprises carbon or a carbon material. In some embodiments, the electroactive layer is or comprises a graphitic material (e.g., graphite). A graphitic material generally refers to a material that comprises a plurality of layers of graphene (i.e., layers comprising carbon atoms covalently bonded in a hexagonal lattice). Adjacent graphene layers are typically attracted to each other via van der Waals forces, although covalent bonds may also be present between one or more sheets, in some instances. In some embodiments, a carbon-comprising electroactive layer is or comprises coke (e.g., petroleum coke). In some embodiments, electroactive layer comprises silicon, lithium, and/or any alloys of combinations thereof. In some embodiments, the electroactive layer comprises lithium titanate (Li₄Ti₅O₁₂, also referred to as “LTO”), tin-cobalt oxide, or any combinations thereof.

The electroactive layer may be of any suitable thickness. In some embodiments, the electroactive layer has a thickness of greater than or equal to 10 μm, greater than or equal to 20 μm, greater than or equal to 30 μm, greater than or equal to 40 μm, greater than or equal to 50 μm, greater than or equal to 75 μm, greater than or equal to 100 μm, or more. In some embodiments, the electroactive layer has a thickness of less than or equal to 100 μm, less than or equal to 75 μm, less than or equal to 50 μm, less than or equal to 40 μm, less than or equal to 30 μm, less than or equal to 20 μm, less than or equal to 10 μm, or less. Combinations of the above-referenced ranges are also possible (e.g., greater than or equal to 10 μm and less than or equal to 100 μm). Other ranges are possible.

The ranges described in the preceding paragraph may characterize the average thickness of the electroactive layer and/or the thickness of any given portion of the electroactive layer.

As mentioned above, some electrochemical cells may include cathode. The second electrode may include a cathode active electrode species.

A variety of chemical species may be suitable for the cathode active electrode species. In some embodiments, the cathode active electrode species comprises lithium, nickel, cobalt, and manganese. In some embodiments, the cathode active electrode species includes, but is not limited to, one or more metal oxides, one or more intercalation materials, electroactive transition metal chalcogenides, electroactive conductive polymers, sulfur, carbon and/or combinations thereof.

In some embodiments, the cathode active electrode species comprises a nickel-cobalt-manganese (NCM) compound, which may reversibly intercalate and deintercalate lithium (e.g., lithium ions). For example, the NCM compound may be a layered oxide, such as lithium nickel manganese cobalt oxide, LiNiₓMn_{y}Co₂O₂. In some such embodiments, the sum of x, y, and z is 1. For example, a non-limiting example of a suitable NCM compound is LiNi_{1/3}Mn_{1/3}Co_{1/3}O₂. In some such embodiments, the NCM compounds has a relatively high nickel content (e.g., greater than or equal to 70 mol %, greater than or equal to 75 mol %, greater than or equal to 80 mol %) relative to other transition metals in the compound. For example, in an NCM811, the relative atomic ratio of nickel, cobalt, and manganese is 8:1:1, respectively, such that the atomic percentage of nickel is 8/(8+1+1), or at 80 mol %. In some embodiments, the NCM compound is (at least initially) free of lithium, but lithium may intercalate into the compound during cycling (e.g., during one or more formation cycles).

In some embodiments, a cathode active electrode species is a lithium transition metal oxide (other than NCM) or a lithium transition metal phosphate. Non-limiting examples include LiₓCoO₂ (e.g., Li_{1.1}CoO₂), LiₓNiO₂, LiₓMnO₂, LiₓMn₂O₄ (e.g., Li_{1.05}Mn₂O₄), LiₓCoPO₄, LiₓMnPO₄, and LiCoₓNi₍₁₋ₓ₎O₂. In some such embodiments, the value of x may be greater than or equal to 0 and less than or equal to 2 and the value of y may be greater than 0 and less than or equal to 2. In some embodiments, x is typically greater than or equal to 1 and less than or equal to 2 when the electrochemical device is fully discharged, and less than 1 when the electrochemical device is fully charged. In some embodiments, a fully charged electrochemical cell may have a value of x that is greater than or equal to 1 and less than or equal to 1.05, greater than or equal to 1 and less than or equal to 1.1, or greater than or equal to 1 and less than or equal to 1.2. Further examples include LiₓNiPO₄, where (0<x≤1), LiMnₓNi_{y}O₄ where (x+y=2) (e.g., LiMn_{1.5}Ni_{0.5}O₄), LiNiₓCo_{y}Al_{z}O₂ where (x+y+2=1), LiFePO₄, and combinations thereof. In some embodiments, a cathode active electrode species within a cathode comprises a lithium transition metal phosphate (e.g., LiFePO₄), which can, in some embodiments, be substituted with borates and/or silicates.

As mentioned above, in some embodiments, a cathode active electrode species may comprise a lithium intercalation compound (i.e., a compound that is capable of reversibly inserting lithium ions at lattice sites and/or interstitial sites). In some embodiments, the cathode active electrode species comprises a layered oxide. A layered oxide generally refers to an oxide having a lamellar structure (e.g., a plurality of sheets, or layers, stacked upon each other). Non-limiting examples of suitable layered oxides include lithium cobalt oxide (LiCoO₂), lithium nickel oxide (LiNiO₂), and lithium manganese oxide (LiMnO₂). In some embodiments, the layered oxide is lithium nickel cobalt aluminum oxide (LiNiₓCo_{y}Al_{z}O₂, also referred to as “′NCA”). In some such embodiments, the sum of x, y, and z is 1. For example, a non-limiting example of a suitable NCA compound is LiNi_{0.8}Co_{0.15}Al_{0.05}O₂. In some embodiments, the electroactive material is a transition metal polyanion oxide (e.g., a compound comprising a transition metal, an oxygen, and/or an anion having a charge with an absolute value greater than 1). A non-limiting example of a suitable transition metal polyanion oxide is lithium iron phosphate (LiFePO₄, also referred to as “LFP”). Another non-limiting example of a suitable transition metal polyanion oxide is lithium manganese iron phosphate (LiMnₓFe₁₋ₓPO₄, also referred to as “LMFP”). A non-limiting example of a suitable LMFP compound is LiMn_{0.8}Fe_{0.2}PO₄. In some embodiments, the cathode active electrode species is a spinel (e.g., a compound having the structure AB₂O₄, where A can be Li, Mg, Fe, Mn, Zn, Cu, Ni, Ti, or Si, and B can be Al, Fe, Cr, Mn, or V). A non-limiting example of a suitable spinel is a lithium manganese oxide with the chemical formula LiMₓMn₂₋ₓO₄ where M is one or more of Co, Mg, Cr, Ni, Fe, Ti, and Zn. In some embodiments, x may equal 0 and the spinel may be lithium manganese oxide (LiMn₂O₄, also referred to as “LMO”). Another non-limiting example is lithium manganese nickel oxide (LiNiₓMn₂₋ₓO₄, also referred to as “LMNO”). A non-limiting example of a suitable LMNO compound is LiNi_{0.5}Mn_{1.5}O₄. In some embodiments, the cathode active electrode species comprises Li_{1.14}Mn_{0.42}Ni_{0.25}Co_{0.29}O₂ (“HC-MNC”), lithium carbonate (Li₂CO₃), lithium carbides (e.g., Li₂C₂, Li₄C, Li₆C₂, Li₂C₃, Li₆C₃, Li₄C₃, Li₄C₅), vanadium oxides (e.g., V₂O₅, V₂O₃, V₆O₁₃), and/or vanadium phosphates (e.g., lithium vanadium phosphates, such as Li₃V₂(PO₄)₃), or any combination thereof.

In some embodiments, a cathode active electrode species comprises a conversion compound. It has been recognized that a cathode comprising a conversion compound may have a relatively large specific capacity. Without wishing to be bound by a particular theory, a relatively large specific capacity may be achieved by utilizing all possible oxidation states of a compound through a conversion reaction in which more than one electron transfer takes place per transition metal (e.g., compared to 0.1-1 electron transfer in intercalation compounds). Suitable conversion compounds include, but are not limited to, transition metal oxides (e.g., Co₃O₄), transition metal hydrides, transition metal sulfides, transition metal nitrides, and transition metal fluorides (e.g., CuF₂, FcF₂, FeF₃). A transition metal generally refers to an element whose atom has a partially filled d sub-shell (e.g., Sc, Ti, V, Cr, Mn, Fe, Co, Ni, Cu, Zn, Y, Zr, Nb, Mo, Tc, Ru, Rh, Pd, Ag, Cd, Hf, Ta, W, Rc, Os, Ir, Pt, Au, Hg, Rf, Db, Sg, Bh, Hs).

In some embodiments, a cathode active electrode species may be doped with one or more dopants to alter the electrical properties (e.g., electrical conductivity) of the species. Non-limiting examples of suitable dopants include aluminum, niobium, silver, and zirconium.

In some embodiments, a cathode active electrode species may be modified by a surface coating comprising an oxide. Non-limiting examples of surface oxide coating materials include: MgO, Al₂O₃, SiO₂, TiO₂, ZnO₂, SnO₂, and ZrO₂. In some embodiments, such coatings may prevent direct contact between the active electrode species and the electrolyte, thereby suppressing side reactions.

In some embodiments, a cathode active electrode species has a particular loading. For example, in some embodiments, the cathode active electrode species has a loading of greater than or equal to 10 mg/cm², greater than or equal to 15 mg/cm², greater than or equal to 20 mg/cm², greater than or equal to 22 mg/cm², or greater than or equal to 25 mg/cm². In some embodiments, the cathode active electrode species has a loading of less than or equal to 30 mg/cm², less than or equal to 25 mg/cm², less than or equal to 22 mg/cm², less than or equal to 20 mg/cm², less than or equal to 15 mg/cm², or less than or equal to 10 mg/cm². Combinations of the above-reference ranges are also possible (e.g., greater than or equal to 10 mg/cm² and less than or equal to 25 mg/cm²). Other ranges are possible.

A layer comprising a cathode active electrode species may have a particular thickness. In some embodiments, a layer comprising a cathode active electrode species has a thickness of greater than or equal to 100 nm, greater than or equal to 250 nm, greater than or equal to 500 nm, greater than or equal to 750 nm, greater than or equal to 1 micron, greater than or equal to 2 microns, greater than or equal to 3 microns, greater than or equal to 5 microns, greater than or equal to 10 microns, greater than or equal to 20 microns, greater than or equal to 25 microns, or greater than or equal to 50 microns. In some embodiments, the layer comprising the cathode active electrode species has a thickness of less than or equal to 50 microns, less than or equal to microns, less than or equal to 20 microns, less than or equal to 10 microns, less than or equal or equal to 5 microns, less than or equal to 3 microns, less than or equal to 2 microns, less than or equal to 1 micron, less than or equal to 750 nm, less than or equal to 500 nm, less than or equal to 250 nm, or less than or equal to 100 nm. Combinations of the above-referenced ranges are also possible (e.g., greater than or equal to 100 nm and less than or equal to 10 microns). Other ranges are possible.

The ranges described in the preceding paragraph may characterize the average thickness of a layer comprising the cathode active electrode species and/or the thickness of any given portion of such a layer.

In some embodiments, a cathode active electrode species is treated with a sulfur-containing material to remove impurities from the active electrode species (e.g., prior to forming an electrode with the active electrode species). In some embodiments, the cathode active electrode species is an intercalation compound. It has been discovered that the use of elemental sulfur and/or other sulfur-containing reactants can allow for selective reacting and removal of impurities from cathode active electrode species and materials. In some embodiments, the formation of a sulfur-containing compound (e.g., a lithium sulfur oxide) within the treated cathode active electrode material may result in improved chemical stability of the treated cathode active electrode material. Without wishing to be bound by any theory, it is believed that formation or inclusion of sulfur-containing compounds within a cathode active electrode material may result in reduced amounts of gas generation during cycling, increased electrode chemical stability, reduced adverse interfacial reactions between the electrode and electrolyte, and/or prolonged cycle life of the electrochemical cell. In some embodiments, the cathode active electrode species is an intercalation compound.

Prior to reacting with a sulfur-containing compound, the impurities associated with a cathode active electrode species (e.g., an intercalation compound) may be present in any of a variety of amounts, depending on the specific type of species. For example, in some embodiments, a cathode active electrode species may contain up to 0.1 wt % (e.g., up to 0.2 wt %, up to 0.3 wt %, up to 0.5 wt %, up to 1 wt %, up to 2 wt %, or up to 3 wt %) of impurities.

Impurities may be associated with a cathode active electrode species in a number of ways. For example, the impurities may be in physical contact with the cathode active electrode species. For example, in some embodiments, impurities may be contained within the cathode active electrode material (i.e., prior to treating with a sulfur-containing compound) and/or may be present on an external surface of the cathode active electrode species.

For some embodiments, impurities associated with a cathode active electrode species may be reacted with a sulfur-containing reactant to form a treated cathode active electrode species. For instance, the cathode active electrode active species, in some instances, may comprise one or more impurities that can render the cathode active electrode species reactive and unstable. Non-limiting examples of such impurities associated with a cathode active electrode species include Li₂CO₃, LiOH, Li₂O, NIO, Ni(OH)₂, transition metal oxides, hydroxides, and oxyhydroxides. In some embodiments, reacting the impurities associated with the cathode active electrode species with a sulfur-containing reactant may advantageously result in the formation of a treated cathode active electrode species with enhanced chemical stability. For example, the presence of one or more impurities associated with a cathode active electrode species may lead to undesired gas generation during cycling of the cathodel. Accordingly, reacting the impurities associated with the cathode active electrode species with a sulfur-containing reactant may result in a cathode active electrode species having fewer impurities that are capable of gas generation.

In some embodiments, after undergoing a reaction, the reacted species may be dried to form a treated cathode active electrode species. The treated cathode active electrode species may, in some embodiments, include a reduced amount of impurities, relative to the untreated species, all other factors being equal. Furthermore, reacting of the cathode active electrode species and/or impurities associated with the cathode active electrode species may lead to the formation of a sulfur-containing compound (e.g., Li₂SO₄). In some embodiments, the treated cathode active electrode species is a part of (or can be used to form) a cathode, which can be used in an electrochemical cell.

In some embodiments, it may be advantageous to form a certain type of sulfur-containing compound, e.g., such as a particular type of lithium sulfur oxide (e.g., Li₂SO₄). Without wishing to be bound by any particular theory, it is believed that the formation and/or presence of a certain type of lithium sulfur oxide (e.g., Li₂SO₄) within the treated cathode active electrode species (e.g., a lithium intercalation compound) may advantageously decrease the surface reactivity of the cathode active electrode species, thereby increasing the stability of a cathode active electrode species (e.g., an intercalation compound) and/or electrode comprising the cathode active electrode species, and reducing the amount of gas generated when the cathode is subjected to a number of charge and discharge cycles.

In some embodiments, the sulfur-containing compound reacted with the (impure) cathode active electrode species comprises Li₂SO₄ as a reaction product formed from the reaction between the sulfur-containing reactant and the active electrode species and/or impurities (e.g., Li₂CO₃, LiOH) associated with the cathode active electrode species. In some embodiments, a small amount, if any, of other products may be formed along with Li₂SO₄. In some such embodiments, the reaction products include one or more of Li₂S₂O₃, Li₂S, Li₂SO₃, NIS, NIO, NiSO₄, NiSO₃, CO₂S₃, CO₂(SO₄)₃, and/or Co₂(SO₃)₃.

In some embodiments, the sulfur-containing compound is reacted with a cathode active electrode species comprising a nickel-containing, a cobalt-containing, and/or a manganese-containing intercalation compound, the amount (mol %) of Li₂SO₄ present after the reacting may be at least 2 (e.g., at least 4, at least 5, at least 10, at least 100, at least 500, at least 1000, at least 10,000, or at least 100,000) times the amount (mol %) of other lithium sulfur oxides (e.g., Li₂S₂O₃ and/or Li₂SO₃). In some such embodiments in which the intercalation compound is a nickel-containing intercalation compound, Li₂SO₄ may be formed as the sole reaction product. In some embodiments in which the intercalation compound is a cobalt-containing intercalation compound, the reaction product contains predominately Li₂SO₄, along with a relatively smaller amount of Li₂SO₃ and/or Li₂S₂O₃, as described in one or more of the ranges above.

In some embodiments, a small amount, if any, of NiO may be present after the reacting the sulfur (or sulfur-containing compound) with a cathode active electrode species when the cathode active electrode species is a nickel-containing intercalation compound. In some such embodiments, NiO is not present after the reacting, or the amount of NiO present after the reacting is relatively low compared to an amount of Li₂SO₄ (if present). In some embodiments in which NiO is present, the amount of NiO present after the reacting is such that a mole ratio of Li₂SO₄ to NiO is greater than or equal to 0.5 (e.g., greater than or equal to 1, greater than or equal to 2, greater than or equal to 5, greater than or equal to 10, greater than or equal to 100, greater than or equal to 1,000, greater than or equal to 10,000, or greater than or equal to 100,000). Other mole ratios are possible.

In some embodiments, a cathode comprises an external active surface, an intercalation compound containing a cathode active electrode species, and a sulfur-containing compound, wherein the external active surface does not contain NiO or contains NiO across less than 50% of a surface area of the external active surface, and the external active surface does not contain NiSO₃ or contains NiSO₃ across less than 50% of a surface area of the external active surface. In some embodiments, the cathode comprises an external active surface, an intercalation compound containing the cathode active electrode species, and Li₂SO₄, wherein the external active surface does not contain NiO or contains an amount of NiO such that the mole ratio of Li₂SO₄ to NIO is greater than 0.5, and the external active surface does not contain NiSO₃ or contains NiSO₃ such that the mole ratio of Li₂SO₄ to NiSO₃ is greater than 0.5.

In some embodiments, the cathode comprises an external active surface, an intercalation compound containing the cathode active electrode species, and a sulfur-containing compound, wherein the external active surface does not contain Li₂S₂O₃ or contains Li₂S₂O₃ across less than 30% of a surface area of the external active surface, and the external active surface does not contain NiSO₃ or contains NiSO₃ across less than 50% of a surface area of the external active surface; and the cathode has not been subjected to a charge/discharge cycle.

In some embodiments, the cathode comprises an external active surface, an intercalation compound containing the cathode active electrode species, and Li₂SO₄, wherein the external active surface does not contain Li₂S₂O₃ or contains an amount of Li₂S₂O₃ such that the mole ratio of Li₂SO₄ to Li₂S₂O₃ is greater than 2; the cathode does not contain NiSO₃ or contains NiSO₃ such that the mole ratio of Li₂SO₄ to NiSO₃ is greater than 0.5; and the cathode has not been subjected to a charge/discharge cycle.

In some embodiments, a cathode may comprise a binder. The binder can hold the cathode active electrode species together with electronically conductive particles (e.g., carbon block), in addition to providing, at least some, mechanical support to the cathode. A variety of materials may be suitable for the binder. For example, the binder may comprise a polymeric binder. In some embodiments, the polymeric binder comprises a polyvinylidene difluoride (PVDF) polymer. However, other polymeric binders are possible. Non-limiting examples of other polymeric binders include polyether sulfone, polyether ether sulfone, polyvinyl alcohol, polyvinyl acetate, and polybenzimidazole. Additional non-limiting examples of polymeric binders include a poly(vinylidene fluoride copolymer) such as a copolymer with hexafluorophosphate, a poly(styrene)-poly(butadiene) copolymer, a poly(styrene)-poly(butadiene) rubber, carboxymethyl cellulose, and poly(acrylic acid). In some embodiments, the binder comprises a fluorinated compound. Other polymeric binders are possible.

In some embodiments, the weight percentage of binder within a cathode is greater than or equal to 1 wt %, greater than or equal to 2 wt %, greater than or equal to 3 wt %, greater than or equal to 4 wt %, greater than or equal to 5 wt %, greater than or equal to 6 wt %, greater than or equal to 7 wt %, greater than or equal to 8 wt %, greater than or equal to 9 wt %, greater than or equal to 10 wt %. In some embodiments, the wt % of binder in the cathode is less than or equal to 10 wt %, less than or equal to 9 wt %, less than or equal to 8 wt %, less than or equal to 7 wt %, less than or equal to 6 wt %, less than or equal to 5 wt %, less than or equal to 4 wt %, less than or equal to 3 wt %, less than or equal to 2 wt %, or less than or equal to 1 wt %. Combinations of the above-referenced ranges are also possible (e.g., greater than or equal to 1 wt % and less than or equal to 3 wt %). Other ranges are possible.

As mentioned above, a binder may also comprise an electronically conductive material (e.g., conductive carbon). In some embodiments, the electronically conductive material comprises carbon, such as elemental carbon. Elemental carbon contains carbon in an oxidation state of zero. The elemental carbon can contain sp³- and/or sp²-hybrized carbon atoms. In some embodiments, the elemental carbon contains almost exclusively carbon atoms and hence contains a relatively high atomic percent (mol %) of carbon atoms (e.g., 98 mol % carbon, 99 mol % carbon, 99.9 mol %). In some embodiments, the elemental carbon contains trace amounts (e.g., less than 2 mol %, less than 1 mol %, less than 0.1 mol %) of other elements (e.g., hydrogen, nitrogen, oxygen, sulfur), for example, on the surface to terminate dangling bonds of the elemental carbon. In some embodiments, the electronically conductive material comprises carbon black. In some embodiments, the amount of the electronically conductive material (e.g., carbon black) relative to the binder or within a cathode is greater than or equal to 0.1 wt %, greater than or equal to 0.5 wt %, greater than or equal to 1 wt %, greater than or equal to 2 wt %, greater than or equal to 3 wt %, greater than or equal to 4 wt %, greater than or equal to 5 wt %, greater than or equal to 10 wt %, greater than or equal to 15 wt %, or greater than or equal to 20 wt %. In some embodiments, the amount of the electronically conductive material (e.g., carbon black) relative to the binder or within a cathode is less than or equal to 20 wt %, less than or equal to 15 wt %, less than or equal to 10 wt %, less than or equal to 5 wt %, less than or equal to 4 wt %, less than or equal to 3 wt %, less than or equal to 2 wt %, less than or equal to 1 wt %, less than or equal to 0.5 wt %, or less than or equal to 0.1 wt %. Combinations of the above-referenced ranges are also possible (e.g., greater than or equal to 0.1 wt % and less than or equal to 20 wt %). Other ranges are possible.

In some embodiments, other electronically conductive materials can be used and may include, for example, other conductive carbons such as graphite fibers, graphite fibrils, graphite powder (e.g., Fluka #50870), activated carbon fibers, carbon fabrics, and non-activated carbon nanofibers, without limitation. Other non-limiting examples of electronically conductive materials include metal-coated glass particles, metal particles, metal fibers, nanoparticles, nanotubes, nanowires, metal flakes, metal powders, metal fibers, and metal meshes.

A cathode may be porous or comprise a porous region. Thus, in some embodiments, a cathode may comprise one or more pores. In some embodiments, the cathode comprising pores (e.g., the porous cathode) is an intercalation electrode. The pores of a cathode or a portion of the cathode may be of any of a variety of suitable sizes (e.g., measured as an average cross-sectional pore diameter). For example, in some embodiments, the pores of a porous portion can be sufficiently large to allow for the passage of liquid electrolyte into the pores of an electrode due to, for example, capillary forces. In addition, in some embodiments, the pores may be smaller than millimeter-scale or micron-scale pores, which may be too large such that they render the cathode mechanically unstable. In some embodiments, the pores have an average cross-sectional diameter of greater than or equal to 0.2 nm, greater than or equal to 0.5 nm, greater than or equal to 1 nm, greater than or equal to 5 nm, greater than or equal to 10 nm, greater than or equal to 20 nm, greater than or equal to 30 nm, greater than or equal to 40 nm, greater than or equal to 50 nm, greater than or equal to 100 nm, or more. In some embodiments, the pores have an average cross-sectional diameter of less than or equal to 500 nm, less than or equal to 400 nm, less than or equal to 300 nm, less than or equal to 200 nm, less than or equal to 100 nm, or less. Combinations of the above-referenced ranges are also possible (e.g., greater than or equal to 0.2 nm and less than or equal to 200 nm). Other ranges are possible. The cross-sectional diameter of a pore and the average cross-sectional pore diameter of a cathode can be measured via mercury intrusion porosimetry using ASTM Standard Test D4284-07.

In some embodiments, a cathode may have a porosity or a porous portion with a low porosity. Low porosity cathodes may advantageously exhibit an increased volumetric energy density relative to higher porosity cathodes. The term “porosity” is generally used herein to describe the ratio of void volume to overall volume and is expressed as a percentage. The porosity can be determined by dividing the void volume of the cathode or portion thereof by the overall volume of the cathode or portion thereof and multiplying the result by 100%, where the void volume refers to the portions of a particular portion that are capable of being occupied by a liquid or a gas. Some or all of the void volume may be capable of being occupied by a liquid or a gas (e.g., a liquid electrolyte). The void volume of the cathode would not include, for example, the volume occupied by a lithium intercalation compound, an electronically conductive material (e.g., carbon black), or any solid binder material. The porosity of a cathode or a porous portion thereof can be measured via mercury intrusion porosimetry, using a standard test such as ASTM Standard Test D4284-07.

As mentioned above, a cathode or a porous portion thereof (e.g., a porous electroactive region) may have a relatively low porosity. For example, in some embodiments, a cathode and/or the porous portion of a cathode has a porosity of less than or equal to 20%, less than or equal to 18%, less than or equal to 17%, less than or equal to 16%, less than or equal to 15%, less than or equal to 12%, less than or equal to 10%, less than or equal to 9%, less than or equal to 8%, less than or equal to 7%, less than or equal to 6%, or less. In some embodiments, a cathode and/or the porous portion of a cathode has a porosity of greater than or equal to 3%, greater than or equal to 5%, greater than or equal to 6%, greater than or equal to 7%, greater than or equal to 8%, greater than or equal to 10%, greater than or equal to 12%, greater than or equal to 15%, or more. Combinations of the above-referenced ranges are also possible (e.g., greater than or equal to 5% and less than or equal to 16%). Other ranges are also possible.

In some embodiments, a cathode and/or a porous portion of a cathode may have a relatively high porosity. For example, in some embodiments, a cathode and/or a porous portion thereof has a porosity of greater than or equal to 20%, greater than or equal to 30%, greater than or equal to 50%, or greater than or equal to 70%. In some embodiments, a cathode and/or a porous portion thereof has a porosity of less than or equal to 70%, less than or equal to 50%, less than or equal to 30%, or less than or equal to 20%. Combinations of the above-referenced ranges are also possible (e.g., greater than or equal to 20% and less than or equal to 70%).

Various embodiments described herein may include a current collector. A current collector may be positioned adjacent to (e.g., directly adjacent to) an electroactive layer, an electrode, and/or an active electrode species of an electrode. A current collector can facilitate the collection and transfer of current so that it can be delivered for its desired application. A current collector, when present, may be of any suitable material. Suitable current collectors may include, for example, metals, metal foils (e.g., aluminum foil), polymer films, metallized polymer films (e.g., aluminized plastic films, such as aluminized polyester film), electrically conductive polymer films, polymer films having an electrically conductive coating, electrically conductive polymer films having an electrically conductive metal coating, and polymer films having conductive particles dispersed therein. In some embodiments, the current collector includes one or more conductive metals such as aluminum, copper, magnesium, chromium, stainless steel and/or nickel. For example, a current collector may include a copper and/or magnesium metal layer on at least a portion of the current collector. Optionally, a current collector may include more than one layers. For instance, another conductive metal layer, such as magnesium or titanium, may be positioned on a copper layer. For example, as mentioned above, in some embodiments, a current collector (e.g., a copper current collector) has magnesium deposited on at least a portion of a surface of the current collector. Additional current collectors may include, for example, expanded metals, metal mesh, metal grids, expanded metal grids, metal wool, woven carbon fabric, woven carbon mesh, non-woven carbon mesh, and carbon felt. Furthermore, a current collector may be electrochemically inactive. In some embodiments, a current collector may comprise an active electrode species or have an active electrode species deposited on at least a portion a surface of the current collector.

In some embodiments, a current collector may be present without an active electrode species (e.g., an anode active electrode species, a cathode active electrode species) present during at least a portion of a charge/discharge cycle. In such an embodiment, the current collector may act as an electrode precursor in which, during formation and/or during subsequent charge/discharge cycles, an active electrode species (e.g., an active anode species such as lithium) may be formed (or deposited) on at least a portion of a surface of the current collector.

A current collector may have any suitable thickness. For instance, the thickness of a current collector may be greater than or equal to 0.1 microns, greater than or equal to 0.3 microns, greater than or equal to 0.5 microns, greater than or equal to 1 micron, greater than or equal to 3 microns, greater than or equal to 5 microns, greater than or equal to 7 microns, greater than or equal to 9 microns, greater than or equal to 10 microns, greater than or equal to 12 microns, greater than or equal to 15 microns, greater than or equal to 20 microns, greater than or equal to 25 microns, greater than or equal to 30 microns, greater than or equal to 40 microns, or greater than or equal to 50 microns. In some embodiments, the thickness of the current collector may be less than or equal to 50 microns, less than or equal to 40 microns, less than or equal to 30 microns, less than or equal to 25 microns, less than or equal to 20 microns, less than or equal to microns, less than or equal to 12 microns, less than or equal to 10 microns, less than or equal to 9 microns, less than or equal to 7 microns, less than or equal to 5 microns, less than or equal to 3 microns, less than or equal to 1 micron, less than or equal to 0.5 microns, less than or equal to 0.3 microns, or less than or equal to 0.1 microns. Combinations of the above-referenced ranges are also possible (e.g., greater than or equal to 0.3 microns and less than or equal to 15 microns). Other ranges are possible.

The ranges described in the preceding paragraph may characterize the average thickness of the current collector and/or the thickness of any given portion of the current collector.

In some embodiments, an electrochemical cell includes a separator, for example, between the anode and the cathode. The separator may be a solid, non-electronically conductive or insulative material which separates or insulates the anode and the cathode from each other preventing short circuiting, and which permits the transport of ions between the anode and the cathode. That is to say, the separator can be electronically insulating but ionically conductive. In some embodiments, the separator can be porous and may be permeable to a liquid electrolyte. In some such embodiments, the pores of the separator may be partially or substantially filled with liquid electrolyte. In some embodiments, separators may be supplied as porous, free-standing films which are interleaved with the first electrode and the second electrode during the fabrication of cells. Alternatively, the separator layer may be applied directly to the surface of one of the electrodes.

The separator may include a variety of suitable materials. For example, in some embodiments, the separator comprises a polymer as the separator material. Examples of suitable separator materials include, but are not limited to, polyolefins, such as, for example, polyethylenes (e.g., SETELA™ made by Tonen Chemical Corp) and/or polypropylenes, glass fiber filter papers, and ceramic materials. For example, in some embodiments, the separator comprises a microporous polyethylene film. Additional examples of separators and separator materials suitable for use in this disclosure are those comprising a microporous xerogel layer, for example, a microporous pseudo-boehmite layer, which may be provided either as a free-standing film or by a direct coating application on one of the electrode. In some embodiments, solid electrolytes and gel electrolytes may also function as a separator in addition to performing their electrolyte functions.

A separator may be of any suitable thickness that provides adequate physical separation between the anode and the cathode. In some embodiments, the separator has a thickness of greater than or equal to 1 micron, greater than or equal to 2 microns, greater than or equal to 3 microns, greater than or equal to 4 microns, greater than or equal to 5 microns, greater than or equal to 6 microns, greater than or equal to 9 microns, greater than or equal to 12 microns, greater than or equal 15 microns, greater than or equal to 20 microns, greater than or equal to 25 microns, or more. In some embodiments, the separator has a thickness of less than or equal to 25 microns, less than or equal to 20 microns, less than or equal to 15 microns, less than or equal to 12 microns, less than or equal to 9 microns, less than or equal to 6 microns, less than or equal to 5 microns, less than or equal to 4 microns, less than or equal to 3 microns, less than or equal to 2 microns, less than or equal to 1 micron, or less. Combinations of the above-referenced ranges are also possible (e.g., greater than or equal to 3 microns and less than or equal to 12 microns). Other ranges are also possible.

The ranges described in the preceding paragraph may characterize the average thickness of the separator and/or the thickness of any given portion of the separator.

In some embodiments, a separator includes a z-fold or accordion fold. For example, various electrochemical cells include a z-folded separator. In some such embodiments, an anode and/or a cathode may also be folded. In some embodiments, an anode is folded in a first direction and a z-folded separator that is z-folded in a second direction, which is orthogonal to the first direction. Additionally or alternatively, exemplary electrochemical cells may include an anode that is z-folded along a first direction and a combination of a cathode and a separator that is z-folded in a second direction, which is orthogonal to the first direction.

In some embodiments, an electrochemical cell includes an anode (e.g., comprising an electroactive layer and, possibly, a protective layer described herein), a separator overlaying the anode, the separator folded back upon itself in a first direction to form a first separator section, a second separator section and an opening there between, and a cathode comprising a plate, wherein the plate is between the first separator section and the second separator section. The anode may be folded over the separator in a second direction, which is orthogonal to the first direction, to form a first anode section underlying the first separator section and a second anode section overlying the second separator section. In some embodiments, an electrochemical cell includes a plurality (e.g., greater than two, greater than three, greater than four) of anode sections, separator sections, and plates, such that the anode and the separator each form z-folded layers. In some embodiments, the anode includes an electroactive layer, which may be patch coated onto another electrochemical cell component. In some embodiments, the anode comprises an electroactive layer. In accordance with yet additional embodiments, the folded separator may overlap the plate(s) in areas where the plate(s) are overlapped by the folded anode to prevent shorting between the anode and the cathode. The use of the folds may allow for the relatively easy and inexpensive manufacture of cells with starting materials in the form of, for example, a continuous or semi-continuous roll, tape, or web comprising an electroactive layer (and, possibly, a protective layer) and separator material, and the use of cathode plate(s) allows for the formation of a cell with relatively even pressure distribution.

Some embodiments relate to articles and/or electrochemical cells that comprise a release layer. These release layers may facilitate the case of fabrication, arrangements, assemblies, methods of electrochemical cell components, such as electrodes. The release layer may facilitate the lamination/delamination of adjacent layers during electrochemical cell fabrication by facilitate facile removal of adjacent layers from certain electrochemical cell fabrication components (e.g., substrates). In some embodiments, the release layer may be removed prior to the final assembly of an electrochemical cell, but in other embodiments, the release may be left within the final electrochemical cell.

In some embodiments, the release layer is a non-electronically conductive release layer. In some embodiments, the release layer is an electronically conductive release layer that can conduct electrons, for example, from one portion of the conductive release layer (e.g., a first surface) to another portion of the conductive release layer (e.g., a second surface). In some embodiments, it may be beneficial for to provide a conductive release layer that separates portions of an article and/or electrode from a carrier substrate (e.g., a metal foil) on which the article and/or electrode was fabricated and/or an adjacent electrode and/or active electrode material. For example, an intermediate article and/or electrode assembly may include, in sequence, an electroactive layer comprising lithium, a current collector, a conductive release layer, and a carrier substrate. In some embodiments, an intermediate article and/or electrode assembly may include, in sequence, an article (e.g., comprising an electroactive layer comprising lithium and/or a protective layer), a conductive release layer, and a carrier substrate. In one or both of these embodiments, the carrier substrate can facilitate handling of the article and/or electrode during fabrication and/or assembly, but may be released (e.g., by the conductive release layer) from the article and/or electrode prior to commercial use and/or prior to incorporation into a final electrochemical cell.

By contrast, certain existing methods of fabricating electrodes involve depositing electrode components onto a substrate that is eventually incorporated into an electrochemical cell (e.g., a battery). The substrate must be of sufficient thickness and/or formed of a suitable material in order to be compatible with the electrode and/or article fabrication process. For example, fabrication of an anode and/or article comprising an electroactive layer comprising lithium metal may involve vacuum deposition of lithium metal at relatively high temperatures and high rates that would cause certain substrates to buckle unless the substrate was made of a particular material and/or had a sufficient thickness. Some substrates that are suitable for such fabrication steps may, however, end up reducing the performance of the cell if the substrate is incorporated into the cell. For instance, thick substrates may prevent buckling and therefore allow the deposition of a thick layer of lithium metal but may reduce the specific energy density of the cell. Furthermore, certain substrates that are incorporated into the electrochemical cell may react adversely with chemical species within the electrochemical cell during cycling. Furthermore, in some existing systems, if lithium metal was positioned (e.g., deposited) adjacent to an electroactive layer (e.g., comprising lithium metal) with a non-conductive release layer in between the two electroactive layers and then positioned in an electrochemical cell or a battery, the non-conductive release layer would be an isolative layer between two layers, which would result in uneven distribution and utilization of the two electroactive layers when utilized in an electrochemical cell, system, or battery. As a result, during cycling of the cell, the utilization of active electrode species (e.g., lithium metal) on both sides can be uneven and/or negatively impact performance.

In some embodiments, an article and/or electrode can be fabricated to include a conductive release layer to separate portions of the article and/or electrode. Advantageously, such systems and methods allow for a larger variety of substrates and/or more extreme processing conditions to be used when fabricating articles and/or electrodes compared to that when a conductive release layer is not used. In addition, the use of a conductive release layer may provide electronic communication between two adjacent the electrodes and/or articles (and/or two adjacent electroactive layers) through the conductive release layer, which may result in more uniform current distribution and lithium metal utilization during cycling inside the electrochemical cell when compared to certain existing systems and methods that utilize a non-conductive release layer (all other relevant factors being equal). For example, in some embodiments, a conductive release layer may be positioned in between (e.g., directly between) two electrodes and/or articles (e.g., of the same type, such as two anodes) such that the electrodes and/or articles are in electronic communication through the conductive release layer. In some such embodiments, the active electrode species can be the same (e.g., both may comprise lithium metal, such as in the form of an electroactive layer comprising lithium metal) or different. Of course, it is again noted that some embodiments do not include an electronically conductive release layer (i.e., some embodiments may include an electronically non-conductive release layer, or may contain no release layer at all).

Several factors may be considered in determining the type of release layer of an electrochemical cell, including, but not limited to, the nature of the adjacent electrodes and/or other electrochemical cell components in which a release layer would be placed in between. Other factors in considering the release layer include, without limitation, relatively good adhesion to a first component (e.g., an electrode, a current collector, a protective layer, a substrate) but relatively moderate or poor adhesion to a second component (e.g., a carrier substrate, a current collector); the degree of electrical resistance/conductivity; high mechanical stability to facilitate delamination without mechanical disintegration; high thermal stability; ability to withstand the application of a force or pressure applied to the electrochemical cell or a component of the cell during fabrication and/or during cycling of the cell; and compatibility with processing conditions (e.g., deposition of layers on top of the release layer, as well as compatibility with techniques used to form the release layer). Release layers may be thin (e.g., less than 10 microns) to reduce overall weight if the conductive release layer is incorporated into the electrochemical cell. Furthermore, release layers, when incorporated into a cell, should be stable in the electrolyte and should not interfere with the structural integrity of the electrodes in order for the electrochemical cell to have a high electrochemical capacity or energy storage capability (i.e., reduced capacity fade). In some embodiments, release layers from two electrode and/or article portions can be adhered together, optionally using an adhesion promoter as described in more detail below.

As described herein, a release layer may be chosen based on, for example, its inertness in the electrolyte and whether the release layer is to be incorporated into the electrochemical cell. The particular materials used to form the release layer may depend on, for example, the material compositions of the layers to be positioned adjacent the release layer and its adhesive affinity to those layers, as well as the thicknesses and method(s) used to deposit each of the layers. The dimensions of the release layer may be chosen such that the electrochemical cell has a low overall weight, while providing suitable release properties during fabrication.

One simple screening test for choosing appropriate materials for a release layer may include forming the release layer and immersing the layer in an electrolyte and observing whether inhibitory or other destructive behavior (e.g., disintegration) occurs compared to that in a control system. The same can be done with other layers (e.g., one or more of the conductive release layers, electroactive layer, protective layer, an adhesion promoter, and/or another release layer) attached to the release layer. Another simple screening test may include forming an electrode and/or article including the one or more release layers and immersing the electrode in the electrolyte of the battery in the presence of the other battery components, discharging/charging the battery, and observing whether specific discharge capacity is higher or lower compared to a control system. A high discharge capacity may indicate no or minimal adverse reactions between the release layer and other components of the battery.

To test whether a release layer has adequate adhesion to one surface but relatively low adhesion to another surface to allow the release layer to be released, the adhesiveness or force required to remove a release layer from a unit area of a surface can be measured (e.g., in units of N/m²). Adhesiveness can be measured using a tensile testing apparatus or another suitable apparatus. Such experiments can optionally be performed in the presence of a solvent (e.g., an electrolyte) or other components to determine the influence of the solvent and/or components on adhesion. In some embodiments, mechanical testing of tensile strength or shear strength can be performed. For example, a release layer may be positioned on a first surface and opposite forces can be applied until the surfaces are no longer joined. The (absolute) tensile strength or shear strength is determined by measuring the maximum load under tensile or shear, respectively, divided by the interfacial area between the articles (e.g., the surface area of overlap between the articles). The normalized tensile strength or shear strength can be determined by dividing the tensile strength or shear strength, respectively, by the mass of the release layer applied to the articles. In one set of embodiments, a “T-peel test” is used. For example, a flexible article such as a piece of tape can be positioned on a surface of the release layer, and the tape can be pulled away from the surface of the other layer by lifting one edge and pulling that edge in a direction approximately perpendicular to the layer so that as the tape is being removed, it continually defines a strip bent at approximately 90 degrees to the point at which it diverges from the other layer. In other embodiments, relative adhesion between layers can be determined by positioning a release layer between two layers (e.g., between a carrier substrate and a current collector), and a force applied until the surfaces are no longer joined. In some such embodiments, a release layer that adheres to a first surface but releases from a second surface, without mechanical disintegration of the release layer, may be useful as a release layer for fabricating components of an electrochemical cell. The effectiveness of an adhesion promoter to facilitate adhesion between two surfaces can be tested using similar methods.

The percent difference in adhesive strength between the release layer and the two surfaces in which the release layer is in contact may be calculated by taking the difference between the adhesive strengths at these two interfaces. For instance, for a release layer positioned between two layers (e.g., between a carrier substrate and a current collector), the adhesive strength of the release layer on the first layer (e.g., a carrier substrate) can be calculated, and the adhesive strength of the release layer on the second layer (e.g., a current collector) can be calculated. The smaller value can then be subtracted from the larger value, and this difference divided by the larger value to determine the percentage difference in adhesive strength between each of the two layers and the release layer. In some embodiments, this percent difference in adhesive strength is greater than 20%, greater than 30%, greater than 40%, greater than 50%, greater than 60%, greater than 70%, or greater than 80%. The percentage difference in adhesive strength may be tailored by methods described herein, such as by choosing appropriate materials for each of the layers.

A peel test may include measuring the adhesiveness or force required to remove a layer (e.g., a conductive release layer) from a unit area of a surface of a second layer (e.g., an electroactive layer), which can be measured in N/m, using a tensile testing apparatus or another suitable apparatus. One example of a peel test that can be used is the MARK-10 BG5 gauge with ESM301 motorized test stand.

In some embodiments, the strength of adhesion between two layers (e.g., a release layer and an adjacent electrode) may range, for example, between 0.01 N/m to 2000 N/m. In some embodiments, the strength of adhesion may be greater than or equal to 0.01 N/m, greater than or equal to 0.02 N/m, greater than or equal to 0.04 N/m, greater than or equal to 0.06 N/m, greater than or equal to 0.08 N/m, greater than or equal to 0.1 N/m, greater than or equal to 0.5 N/m, greater than or equal to 1 N/m, greater than or equal to 10 N/m, greater than or equal to 25 N/m, greater than or equal to 50 N/m, greater than or equal to 100 N/m, greater than or equal to 200 N/m, greater than or equal to 350 N/m, greater than or equal to 500 N/m, greater than or equal to 700 N/m, greater than or equal to 900 N/m, greater than or equal to 1000 N/m, greater than or equal to 1200 N/m, greater than or equal to 1400 N/m, greater than or equal to 1600 N/m, or greater than or equal to 1800 N/m. In some embodiments, the strength of adhesion may be less than or equal to 2000 N/m, less than or equal to 1500 N/m, less than or equal to 1000 N/m, less than or equal to 900 N/m, less than or equal to 700 N/m, less than or equal to 500 N/m, less than or equal to 350 N/m, less than or equal to 200 N/m, less than or equal to 100 N/m, less than or equal to 50 N/m, less than or equal to 25 N/m, less than or equal to 10 N/m, less than or equal to 1 N/m, less than or equal to 0.5 N/m, less than or equal to 0.1 N/m, less than or equal to 0.08 N/m, less than or equal to 0.06 N/m, less than or equal to 0.04 N/m, less than or equal to 0.02 N/m, or less than or equal to 0.01 N/m. Combinations of the above-referenced ranges are also possible (e.g., greater than or equal to 0.1 N/m and less than or equal to 50 N/m). Other ranges are possible.

A release layer can be fabricated by any suitable method. In some embodiments, thermal evaporation, vacuum deposition, sputtering, jet vapor deposition, or laser ablation can be used to deposit a release layer on a surface. The release layer may contain additional components to modify its properties (e.g., polymeric binder for binding and/or mechanical strength, conductive particles such as carbon black).

In some embodiments, a release layer is incorporated into a final electrochemical cell.

The electrochemical cells and systems described herein may also comprise an electrolyte. An electrolyte may provide ionic conductivity between two electrodes. In some embodiments, the electrolyte is a solid electrolyte. In other embodiments, the electrolyte is a liquid electrolyte, comprising one or more solvents (e.g., an electrolyte solvents). For example, in some embodiments, the electrolyte comprises a first solvent comprising a fluorinated carbonate and a second solvent comprising a carbonate.

A variety of solvents may be suitable for the electrolyte. The solvent may be an aqueous solvent or a non-aqueous solvent. Examples of useful non-aqueous solvents (i.e., non-aqueous liquid electrolyte solvents) include, but are not limited to, organic carbonates, N-methyl acetamide, acetonitrile, acetals, ketals, esters (e.g., esters of carbonic acid, sulfonic acid, an/or phosphoric acid), carbonates (e.g., dimethyl carbonate, diethyl carbonate, ethyl methyl carbonate, propylene carbonate, ethylene carbonate, fluoroethylene carbonate, difluoroethylene carbonate), sulfones, sulfites, sulfolanes, suflonimidies (e.g., bis(trifluoromethane)sulfonimide lithium salt), ethers (e.g., aliphatic ethers, acyclic ethers, cyclic ethers), glymes, polyethers, phosphate esters (e.g., hexafluorophosphate), siloxanes, dioxolanes, N-alkylpyrrolidones (e.g., N-methyl-2-pyrrolidone), nitrate containing compounds, substituted forms of the foregoing, and blends thereof. Examples of acyclic ethers that may be used include, but are not limited to, diethyl ether, dipropyl ether, dibutyl ether, dimethoxymethane, trimethoxymethane, 1,2-dimethoxyethane, diethoxyethane, 1,2-dimethoxypropane, and 1,3-dimethoxypropane. Examples of cyclic ethers that may be used include, but are not limited to, tetrahydrofuran, tetrahydropyran, 2-methyltetrahydrofuran, 1,4-dioxane, 1,3-dioxolane, and trioxane. Examples of polyethers that may be used include, but are not limited to, diethylene glycol dimethyl ether (diglyme), triethylene glycol dimethyl ether (triglyme), tetracthylene glycol dimethyl ether (tetraglyme), higher glymes, ethylene glycol divinyl ether, diethylene glycol divinyl ether, triethylene glycol divinyl ether, dipropylene glycol dimethyl ether, and butylene glycol ethers. Examples of sulfones that may be used include, but are not limited to, sulfolane, 3-methyl sulfolane, and 3-sulfolene. Fluorinated derivatives of the foregoing are also useful as liquid electrolyte solvents. These electrolytes may optionally include one or more ionic electrolyte salts (e.g., to provide or enhance ionic conductivity).

In some embodiments, an electrolyte comprises fluoroethylene carbonate. In some embodiments, the total weight of the fluoroethylene carbonate in the electrolyte may be less than or equal to 30 wt %, less than or equal to 28 wt %, less than or equal to 25 wt %, less than or equal to 22 wt %, less than or equal to 20 wt %, less than or equal to 18 wt %, less than or equal to 15 wt %, less than or equal to 12 wt %, less than or equal to 10 wt %, less than or equal to 8 wt %, less than or equal to 6 wt %, less than or equal to 5 wt %, less than or equal to 4 wt %, less than or equal to 3 wt %, less than or equal to 2 wt %, or less than or equal to 1 wt % versus the total weight of the electrolyte. In some embodiments, the total weight of the fluoroethylene carbonate in the electrolyte is greater than 0.2 wt %, greater than 0.5 wt %, greater than 1 wt %, greater than 2 wt %, greater than 3 wt %, greater than 4 wt %, greater than 6 wt %, greater than 8 wt %, greater than 10 wt %, greater than 15 wt %, greater than 18 wt %, greater than 20 wt %, greater than 22 wt %, greater than 25 wt %, or greater than 28 wt % versus the total weight of the electrolyte. Combinations of the above-referenced ranges are also possible (e.g., less than or equal to 0.2 wt % and greater than 30 wt %, less than or equal to 15 wt % and greater than 20 wt %, or less than or equal to 20 wt % and greater than 25 wt %). Other ranges are also possible.

In some embodiments, an electrolyte (e.g., a liquid electrolyte) comprises mixtures of two or more solvents or electrolytes, such as those described herein. For instance, an electrolyte may include a first solvent and a second solvent in one or more of the ranges described below. For example, in some embodiments, mixtures of solvents are selected from the following pairs of solvents: 1,3-dioxolane and dimethoxyethane, 1,3-dioxolane and diethyleneglycol dimethyl ether, 1,3-dioxolane and triethyleneglycol dimethyl ether, 1,3-dioxolane and sulfolane, dimethyl carbonate and ethylene carbonate, and fluoroethylene carbonate and dimethyl carbonate, ethylene carbonate and ethyl methyl carbonate, a fluorinated carbonate solvent and a non-fluorinated carbonate solvent, or other combinations of these and/or other solvents/electrolytes described herein. In some such embodiments, the weight ratio of fluoroethylene carbonate to dimethyl carbonate may be greater than or equal to 5:95, greater than or equal to 10:90, greater than or equal to 15:85, greater than or equal to 20:80, greater than or equal to 25:75, greater than or equal to 30:70, greater than or equal to 40:60, or greater than or equal to 50:50, greater than or equal to 60:40, greater than or equal to 70:30, greater than or equal to 75:25, greater than or equal to 80:20, greater than or equal to 85:15, greater than or equal to 90:10, or greater than or equal to 95:5. In some such embodiments, the weight ratio of fluoroethylene carbonate to dimethyl carbonate is less than or equal to 95:5, less than or equal to 90:10, less than or equal to 85:15, less than or equal to 80:20, less than or equal to 75:25, less than or equal to 70:30, less than or equal to 60:40, less than or equal to 50:50, less than or equal to 40:60, less than or equal to 30:70, less than or equal to 25:75, less than or equal to 20:80, less than or equal to 15:85, less than or equal to 10:90, or less than or equal to 5:95. Combinations of the above-referenced ranges are also possible (e.g., greater than or equal to 5:95 and less than or equal to 50:50). Other ranges are possible. In some embodiments, an additional electrolyte solvent may be present (e.g., a third electrolyte solvent, a fourth electrolyte solvent) and the additional electrolyte solvent may have a ratio with the first electrolyte solvent and/or the second electrolyte solvent within the above-referenced ranges.

In some embodiments, an electrolyte may comprise several species together that are particularly beneficial in combination. For instance, in some embodiments, the electrolyte comprises fluoroethylene carbonate, dimethyl carbonate, and/or one or more salts such as LiPF6. The weight ratio of the two solvents in the mixtures may range, in some embodiments, from 5:95 to 95:5. In some embodiments, a ratio of a first electrolyte solvent to a second electrolyte solvent is greater than or equal to 5:95, greater than or equal to 10:90, greater than or equal to 15:85, greater than or equal to 20:80, greater than or equal to 25:75, greater than or equal to 30:70, greater than or equal to 40:60, or greater than or equal to 50:50, greater than or equal to 60:40, greater than or equal to 70:30, greater than or equal to 75:25, greater than or equal to 80:20, greater than or equal to 85:15, greater than or equal to 90:10, or greater than or equal to 95:5. In some embodiments, a ratio of a first electrolyte solvent to a second electrolyte solvent is less than or equal to 95:5, less than or equal to 90:10, less than or equal to 85:15, less than or equal to 80:20, less than or equal to 75:25, less than or equal to 70:30, less than or equal to 60:40, less than or equal to 50:50, less than or equal to 40:60, less than or equal to 30:70, less than or equal to 25:75, less than or equal to 20:80, less than or equal to 15:85, less than or equal to 10:90, or less than or equal to 5:95. Combinations of the above-referenced ranges are also possible (e.g., greater than or equal to 5:95 and less than or equal to 50:50). Other ranges are possible. In some such embodiments, the weight ratio of fluoroethylene carbonate to dimethyl carbonate may be between 20:80 and 25:75 and the concentration of LiPF₆ in the electrolyte may be between 0.05 M and 2 M (e.g., approximately 1 M) or another range of concentrations as described herein for lithium salts. The electrolyte may further comprise lithium bis(oxalato)borate (e.g., at a concentration between 0.1 wt % and 6 wt %, between 0.5 wt % and 6 wt %, or between 1 wt % and 6 wt % in the electrolyte), and/or lithium tris(oxalato)phosphate (e.g., at a concentration between 1 wt % and 6 wt % in the electrolyte). Other concentrations may also be possible.

In some embodiments, the electrolyte comprises an organic solvent comprising fluoroethylene carbonate at a concentration greater than 10% by weight of the electrolyte, and an aromatic hydrocarbon solvent that is different from the organic solvent, wherein the aromatic hydrocarbon solvent is present at an amount that deviates no more than 40 wt % with respect to a critical amount of aromatic hydrocarbon solvent in the electrolyte, and wherein the critical amount of aromatic hydrocarbon solvent in the electrolyte is an amount at which the electrolyte phase separates from a single liquid phase into at least two or more liquid phases.

In some embodiments, an electrolyte includes both an aromatic hydrocarbon solvent and another (e.g., a second) electrolyte solvent, wherein the aromatic hydrocarbon solvent is different from the electrolyte solvent, and wherein the aromatic hydrocarbon solvent has a formula (C):

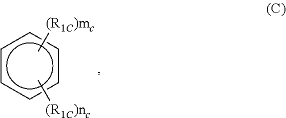

wherein, R_{1C} and R_{2C} can be the same or different and each is independently selected from hydrogen; halogen; unsubstituted, branched or unbranched aliphatic; substituted or unsubstituted, branched or unbranched haloaliphatic; substituted or unsubstituted, branched or unbranched haloheteroaliphatic; substituted or unsubstituted aryl; substituted or unsubstituted haloaryl; substituted or unsubstituted haloheteroaryl; wherein R_{1C} and/or R_{2C} can be substituted, branched or unbranched aliphatic when R_{1C} and R_{2C} are different and are not hydrogen or a nitro group; and wherein n and m are integers from 0 to 6, with n_{c}+m_{c}≤6. In some such embodiments, the aromatic hydrocarbon solvent is present at greater than or equal to 10% by weight of the electrolyte. In some embodiments, the aromatic hydrocarbon solvent is present at an amount that deviates no more than 40 wt % with respect to a critical amount of aromatic hydrocarbon solvent in the electrolyte, and wherein the critical amount of aromatic hydrocarbon solvent in the electrolyte is an amount at which the electrolyte phase separates from a single liquid phase into at least two or more liquid phases.

In some embodiments comprising an electrolyte including two or more solvents, the first solvent may comprise an asymmetric sulfonamide and a second solvent, different from the first solvent. In some embodiments, the second solvent comprises a cyclic carbonate (e.g., propylene carbonate, ethylene carbonate, fluoroethylene carbonate, difluoroethylene carbonate) and/or a linear carbonate (e.g., dimethyl carbonate, diethyl carbonate, ethyl methyl carbonate).

In some embodiments, an electrolyte solvent comprises an asymmetric sulfonamide having a formula (D):

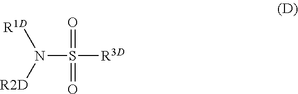

wherein R^{1D} and R^{2D} can be the same or different and each is independently selected from unsubstituted, branched or unbranched aliphatic chains; silyl substituents; or wherein R^{1D} and R^{2D} are connected to form an N-bound heterocycle; wherein, if R^{1D} is selected from unsubstituted, branched or unbranched aliphatic chains, R^{1D} comprises np carbon atoms, where np is an integer greater than or equal to 1 and less than or equal to 10; wherein, if R^{2D} is selected from unsubstituted, branched or unbranched aliphatic chains, R^{2D} comprises m carbon atoms, where m_{D} is an integer greater than or equal to 1 and less than or equal to 10; wherein, if R^{1D} and R^{2D} are connected to form an N-bound heterocycle, the N-bound heterocycle comprises j_{D} carbon atoms, where j_{D} is an integer greater than or equal to 2 and less than or equal to 11; wherein, if R^{1D} and/or R^{2D} is a silyl substituent, the silyl substituent has the form SiR^{4D}₃, where R⁴D is an unsubstituted, branched or unbranched aliphatic chain comprising k_{D} carbon atoms, where k_{D} is an integer greater than or equal to 1 and less than or equal to 10; and wherein R³D is an electron withdrawing species.

In some embodiments, the electrolyte is a heterogenous electrolyte. As used herein, a “heterogeneous electrolyte” is an electrolyte including at least two different liquid solvents (e.g., a first and second electrolyte solvents, or anode-side and cathode-side electrolyte solvents) that are immiscible (or can be made immiscible within an electrochemical cell or system) to the extent that they will largely separate (i.e., phase segregate) and at least one can be isolated from at least one component of the cell. A heterogeneous electrolyte may be in the form of a liquid, a gel, or a combination thereof. Specific examples of heterogeneous electrolytes are provided below.

In some embodiments, the electrolyte comprises a heterogeneous electrolyte, wherein the heterogeneous electrolyte comprises a first electrolyte solvent comprising benzene and a second electrolyte solvent comprising one or more non-aqueous organic solvents selected from the group consisting of carbonates, sulfones, acetals, esters, and ethers. In some such embodiments, the first electrolyte solvent is present disproportionately near the anode and the second electrolyte solvent is present disproportionately near the cathode during use. In some such embodiments, the first and second electrolyte solvents are immiscible with one another during use of electrochemical cell.

For embodiments comprising a heterogenous electrolyte, phase separation of the electrolyte compositions (e.g., a first electrolyte solvent, a second electrolyte solvent) may be carried out in a variety of manners. In one set of techniques, a polymer (which may be a gel) is positioned at a location in the device where it is desirable for a particular electrolyte solvent, which has relatively high affinity for the polymer, to reside. In another set of techniques, two different polymers are positioned in the device at particular locations where two different electrolyte solvents, each having a relatively greater affinity for one of the polymers, are desirably positioned. Similar arrangements can be constructed using more than two polymers. Relatively immiscible electrolyte solvents can be used, and positioned relative to each other, with or without a polymer, and to other components of the device, so as to control exposure of at least one component of the device to a particular species, by exploiting the fact that the species may be more highly soluble in one solvent than the other.

In some embodiments, the electrolyte comprises a heterogeneous electrolyte and is between the anode and a current collector for the cathode, comprising a first electrolyte solvent comprising, for example, 1,3-dioxolane, and a second electrolyte solvent comprising, for example, dimethoxyethane (DME). In some such embodiments, at least a portion of the first electrolyte solvent is present disproportionately in a layer adjacent the anode.

In some embodiments involving a heterogeneous electrolyte, the first electrolyte solvent is present disproportionately near the anode and the second electrolyte solvent is present disproportionately near the cathode, e.g., during use. In some embodiments, the first electrolyte solvent is present disproportionately near or at the anode at a molar or weight ratio of at least 2:1 relative to the second electrolyte solvent, and at least a portion of a second electrolyte solvent is present disproportionately near or at the cathode at a molar or weight ratio of at least 2:1 relative to the first electrolyte solvent. In some such embodiments, the second electrolyte solvent includes at least one species which reacts adversely with the anode.

As mentioned above, in some embodiments, an aqueous solvent can be used with electrolytes. Aqueous solvents include water, which may further comprise other components, such as ionic salts. In some embodiments, the electrolyte can include species such as lithium hydroxide, or other species rendering the electrolyte basic, so as to reduce the concentration of hydrogen ions in the electrolyte.

In some embodiments, liquid electrolyte solvents may be useful as plasticizers for gel polymer electrolytes, i.e., electrolytes comprising one or more polymers forming a semi-solid network. Examples of useful gel polymer electrolytes include, but are not limited to, those comprising one or more polymers selected from the group consisting of polyethylene oxides, polypropylene oxides, polyacrylonitriles, polysiloxanes, polyimides, polyphosphazenes, polyethers, sulfonated polyimides, perfluorinated membranes (NAFION resins), polydivinyl polyethylene glycols, polyethylene glycol diacrylates, polyethylene glycol dimethacrylates, polysulfones, polyethersulfones, derivatives of the foregoing, copolymers of the foregoing, crosslinked and network structures of the foregoing, and blends of the foregoing, and optionally, one or more plasticizers. In some embodiments, a gel polymer electrolyte comprises between 10-20%, between 20-40%, between 60-70%, between 70-80%, between 80-90%, or between 90-95% of a heterogeneous electrolyte by volume.

In some embodiments, one or more gel and/or solid polymers may be used to form the electrolyte. Examples of useful solid polymer electrolytes include, but are not limited to, those comprising one or more polymers selected from the group consisting of polyethers, polyethylene oxides, polypropylene oxides, polyimides, polyphosphazenes, polyacrylonitriles, polysiloxanes, derivatives of the foregoing, copolymers of the foregoing, crosslinked and network structures of the foregoing, and blends of the foregoing.

In addition to electrolyte solvents, gelling agents, and polymers as known in the art for forming electrolytes, the electrolyte may further comprise one or more ionic electrolyte salts, also as known in the art, to increase the ionic conductivity.

An electrolyte salt may be present within the electrolyte. Examples of ionic electrolyte salts for use in the electrolyte of the electrochemical cells described herein include, but are not limited to, LiSCN, LiBr, LiI, LiClO₄, LiAsF₆, LISO₃CF₃, LiSO₃CH₃, LiBF₄, LiB(Ph)₄, LiPF₆, LiC(SO₂CF₃)₃, LIN(SO₂CF₃)₂, and lithium bis(fluorosulfonyl)imide (LiFSI). Other electrolyte salts that may be useful include lithium polysulfides (Li₂Sₓ), and lithium salts of organic polysulfides (LiSₓR)ₙ, where x is an integer from 1 to 20, n is an integer from 1 to 3, and R is an organic group, and those disclosed in U.S. Pat. No. 5,538,812 to Lee et al., which is incorporated herein by reference in its entirety for all purposes.

When present, a lithium salt may be present in the electrolyte at a variety of suitable concentrations. In some embodiments, the lithium salt is present in the electrolyte at a concentration of greater than or equal to 0.01 M, greater than or equal to 0.02 M, greater than or equal to 0.05 M, greater than or equal to 0.1 M, greater than or equal to 0.2 M, greater than or equal to 0.5 M, greater than or equal to 1 M, greater than or equal to 2 M, or greater than or equal to 5 M. The lithium salt may be present in the electrolyte at a concentration of less than or equal to 10 M, less than or equal to 5 M, less than or equal to 2 M, less than or equal to 1 M, less than or equal to 0.5 M, less than or equal to 0.2 M, less than or equal to 0.1 M, less than or equal to 0.05 M, or less than or equal to 0.02 M. Combinations of the above-referenced ranges are also possible (e.g., greater than or equal to 0.01 M and less than or equal to 10 M, or greater than or equal to 0.01 M and less than or equal to 5 M). Other ranges are also possible.

In some embodiments, the electrolyte comprises one or more room temperature ionic liquids. The room temperature ionic liquid, if present, typically comprises one or more cations and one or more anions. Non-limiting examples of suitable cations include lithium cations and/or one or more quaternary ammonium cations such as imidazolium, pyrrolidinium, pyridinium, tetraalkylammonium, pyrazolium, piperidinium, pyridazinium, pyrimidinium, pyrazinium, oxazolium, and trizolium cations. Non-limiting examples of suitable anions include trifluromethylsulfonate (CF₃SO₃⁻), bis (fluorosulfonyl)imide (N(FSO₂)₂⁻, bis (trifluoromethyl sulfonyl)imide ((CF₃SO₂)₂N⁻, bis (perfluorocthylsulfonyl)imide((CF₃CF₂SO₂)₂N⁻ and tris(trifluoromethylsulfonyl)methide ((CF₃SO₂)₃C⁻. Non-limiting examples of suitable ionic liquids include N-methyl-N-propylpyrrolidinium/bis(fluorosulfonyl)imide and 1,2-dimethyl-3-propylimidazolium/bis(trifluoromethanesulfonyl)imide. In some embodiments, the electrolyte comprises both a room temperature ionic liquid and a lithium salt. In some other embodiments, the electrolyte comprises a room temperature ionic liquid and does not include a lithium salt.

As mentioned above, in some embodiments, the electrolyte is a solid electrolyte. In some such embodiments, the solid electrolyte may function as a separator, separating the cathode and the anode such that solid electrolyte can facilitate the transport of ions (e.g., lithium ions) between the cathode and the anode while also being electronically non-conductive to prevent short circuiting. However, it should be understood that, for some embodiments, a battery or a cell may additionally or alternatively comprise a liquid electrolyte. Details regarding liquid electrolytes are described above and elsewhere herein.

In some embodiments, the solid electrolyte comprises a ceramic material (e.g., particles of a ceramic material). Non-limiting examples of suitable ceramic materials include oxides (e.g., aluminum oxide, silicon oxide, lithium oxide), nitrides, and/or oxynitrides of aluminum, silicon, zinc, tin, vanadium, zirconium, magnesium, indium, and alloys thereof, LiₓMP_{y}S_{z} (where x, y, and z are each integers, e.g., integers less than 32, less than or equal to 24, less than or equal 16, less than or equal to 8; and/or greater than or equal to 8, greater than or equal to 16, greater than or equal to 24); and where M=Sn, Ge, or Si) such as Li₂₂SiP₂S₁₈, Li₂₄MP₂S₁₉, or LiMP₂S₁₂ (e.g., where M=Sn, Ge, Si) and LiSiPS, garnets, crystalline or glass sulfides, phosphates, perovskites, anti-perovskites, other ion conductive inorganic materials and mixtures thereof. LiₓMP_{y}S_{z} particles can be formed, for example, using raw components Li₂S, SiS₂ and P₂S₅ (or alternatively Li₂S, Si, S and P₂S₅), for example. In some embodiments, the solid electrolyte comprises a lithium ion-conducting ceramic compound. In an exemplary embodiment, the ceramic compound is Li₂₄SiP₂S₁₉. In another exemplary embodiment, the ceramic compound is Li₂₂SiP₂S₁₈.

In some embodiments, the ceramic material may comprise a material including one or more of lithium nitrides, lithium nitrates (e.g., LiNO₃), lithium silicates, lithium borates (e.g., lithium bis(oxalate)borate, lithium difluoro(oxalate)borate), lithium aluminates, lithium oxalates, lithium phosphates (e.g., LiPO₃, Li₃PO₄), lithium phosphorus oxynitrides, lithium silicosulfides, lithium germanosulfides, lithium oxides (e.g., Li₂O, LiO, LiO₂, LiRO₂, where R is a rare earth metal), lithium fluorides (e.g., LIF, LiBF₄, LiAlF₄, LiPF₆, LiAsF₆, LiSbF₆, Li₂SiF₆, LISO₃F, LIN(SO₂F)₂, LIN(SO₂CF₃)₂), lithium lanthanum oxides, lithium titanium oxides, lithium borosulfides, lithium aluminosulfides, and lithium phosphosulfides, oxy-sulfides (e.g., lithium oxy-sulfides) and combinations thereof. In some embodiments, the plurality of particles may comprise Al₂O₃, ZrO₂, SiO₂, CeO₂, and/or Al₂TiO₅ (e.g., alone or in combination with one or more of the above materials). In a particular embodiment, the plurality of particles may comprise Li—Al—Ti—PO₄ (LATP). The selection of the material (e.g., ceramic) will be dependent on a number of factors including, but not limited to, the properties of the layer and adjacent layers, for example, used in an electrochemical cell.

In some embodiments, an electrolyte is in the form of a layer having a particular thickness. An electrolyte layer may have a thickness of, for example, greater than or equal to 1 micron, greater than or equal to 5 microns, greater than or equal to 10 microns, greater than or equal to 15 microns, greater than or equal to 20 microns, greater than or equal to 25 microns, greater than or equal to 30 microns, greater than or equal to 40 microns, greater than or equal to 50 microns, greater than or equal to 70 microns, greater than or equal to 100 microns, greater than or equal to 200 microns, greater than or equal to 500 microns, or greater than or equal to 1 mm. In some embodiments, the thickness of the electrolyte layer is less than or equal to 1 mm, less than or equal to 500 microns, less than or equal to 200 microns, less than or equal to 100 microns, less than or equal to 70 microns, less than or equal to 50 microns, less than or equal to microns, less than or equal to 30 microns, less than or equal to 20 microns, less than or equal to 10 microns, or less than or equal to 5 microns. Combinations of the above-referenced ranges are also possible (e.g., greater than or equal to 1 micron and less than or equal to 1 mm). Other ranges are possible.

The ranges described in the preceding paragraph may characterize the average thickness of the electrolyte and/or the thickness of any given portion of the electrolyte.

Electrochemical cells described herein may include or be operated under an applied anisotropic force. An “anisotropic force” is a force that is not equal in all directions. In some embodiments, the electrodes or electrochemical cells described herein can be configured to withstand an applied anisotropic force (e.g., a force applied to enhance the morphology or performance of an electrode within the cell) while maintaining their structural integrity. In some embodiments, the articles, electrodes, and/or electrochemical cells are adapted and arranged such that, during at least one period of time during charge and/or discharge of the cell, an anisotropic force with a component normal to the active surface of a layer within the electrochemical cell is applied to the cell.

In some such embodiments, the anisotropic force comprises a component normal to an active surface of an anode and/or a cathode (e.g., an electroactive layer) within an electrochemical cell. As used herein, the term “active surface” is used to describe a surface of an electrode at which electrochemical reactions may take place. A force with a “component normal” to a surface is given its ordinary meaning as would be understood by those of ordinary skill in the art and includes, for example, a force which at least in part exerts itself in a direction substantially perpendicular to the surface. For example, in the embodiment of a horizontal table with an object resting on the table and affected only by gravity, the object exerts a force essentially completely normal to the surface of the table. If the object is also urged laterally across the horizontal table surface, then it exerts a force on the table which, while not completely perpendicular to the horizontal surface, includes a component normal to the table surface. Those of ordinary skill will understand other examples of these terms, especially as applied within the description of this disclosure. In the embodiment of a curved surface (for example, a concave surface or a convex surface), the component of the anisotropic force that is normal to an active surface of an electrode may correspond to the component normal to a plane that is tangent to the curved surface at the point at which the anisotropic force is applied. The anisotropic force may be applied, in some embodiments, at one or more pre-determined locations, in some embodiments distributed over the active surface of an electrode or layer. In some embodiments, the anisotropic force is applied uniformly over the active surface of a layer.

Any of the electrochemical cell properties and/or performance metrics described herein may be achieved, alone or in combination with each other, while an anisotropic force is applied to the electrochemical cell (e.g., during charge and/or discharge of the cell). In some embodiments, the anisotropic force applied to a layer or to the electrochemical cell (e.g., during at least one period of time during charge and/or discharge of the cell) can include a component normal to an active surface of a layer.

In some embodiments, the component of the anisotropic force that is normal to an active surface of a layer or an electrode defines a pressure of greater than or equal to 1 kg/cm², greater than or equal to 2 kg/cm², greater than or equal to 4 kg/cm², greater than or equal to 6 kg/cm², greater than or equal to 7.5 kg/cm², greater than or equal to 8 kg/cm², greater than or equal to 10 kg/cm², greater than or equal to 12 kg/cm², greater than or equal to 14 kg/cm², greater than or equal to 16 kg/cm², greater than or equal to 18 kg/cm², greater than or equal to 20 kg/cm², greater than or equal to 22 kg/cm², greater than or equal to 24 kg/cm², greater than or equal to 26 kg/cm², greater than or equal to 28 kg_{f}/cm², greater than or equal to 30 kg/cm², greater than or equal to 32 kg/cm², greater than or equal to 34 kg_{f}/cm², greater than or equal to 36 kg/cm², greater than or equal to 38 kg/cm², greater than or equal to 40 kg/cm², greater than or equal to 42 kg/cm², greater than or equal to 44 kg/cm², greater than or equal to 46 kg/cm², greater than or equal to 48 kg/cm², or more. In some embodiments, the component of the anisotropic force normal to the active surface may, for example, define a pressure of less than or equal to 50 kg/cm², less than or equal to 48 kg/cm², less than or equal to 46 kg/cm², less than or equal to 44 kg/cm², less than or equal to 42 kg/cm², less than or equal to 40 kg/cm², less than or equal to 38 kg/cm², less than or equal to 36 kg/cm², less than or equal to 34 kg/cm², less than or equal to 32 kg/cm², less than or equal to 30 kg_{f}/cm², less than or equal to 28 kg/cm², less than or equal to 26 kg_{f}/cm², less than or equal to 24 kg/cm², less than or equal to 22 kg/cm², less than or equal to 20 kg/cm², less than or equal to 18 kg_{f}/cm², less than or equal to 16 kg/cm², less than or equal to 14 kg_{f}/cm², less than or equal to 12 kg/cm², less than or equal to 10 kg/cm², less than or equal to 8 kg_{f}/cm², less than or equal to 6 kg/cm², less than or equal to 4 kg/cm², less than or equal to 2 kg/cm², or less. Combinations of the above-referenced ranges are also possible (e.g., greater than or equal to 1 kg/cm² and less than or equal to 50 kg/cm²). Other ranges are possible.

The anisotropic forces applied during at least a portion of charge and/or discharge may be applied using any method known in the art. In some embodiments, the force may be applied using compression springs. Forces may be applied using other elements (either inside or outside a containment structure) including, but not limited to Belleville washers, machine screws, pneumatic devices, and/or weights, among others. In some embodiments, cells may be pre-compressed before they are inserted into containment structures, and, upon being inserted to the containment structure, they may expand to produce a net force on the cell. Suitable methods for applying such forces are described in detail, for example, in U.S. Pat. No. 9,105,938, which is incorporated herein by reference in its entirety.

In some embodiments, one or more electrochemical cells may be operated within an electrochemical cell management system. It has been discovered that, in some embodiments, the cycle life of an electrochemical cell may increase if discharged, over at least a portion of a discharge cycle, at a rate that is at least 2 times greater than a related charging rate of at least a portion of a previous cycle. In some embodiments, a system comprising multiple cells is described where the above discharge/charge ratios are implemented within each individual cell of the system while also allowing the entire collection of cells of the system to provide high capacity and fast charging (i.e., by quickly discharging one subset of cells within the system while slowly charging all others and alternating which subset of cells is being discharged at a given time).

In some embodiments, the electrochemical cell management system is operatively associated with the electrochemical cell. In some embodiments, the electrochemical cell management system comprises at least one controller configured to control the electrochemical cell such that the electrochemical cell is charged at a charging rate over a first state of charge range having breadth of at least 2%. In some embodiments, the at least one controller is configured to control the electrochemical cell such that the electrochemical cell is discharged at a discharging rate over a second state of charge range having a breadth of at least 2%, wherein the discharging rate is at least 2 times the charging rate.

In some embodiments, one or more electrochemical cells may be cycled (i.e., charged/discharged) without a significant (e.g., less than or equal to 20%, less than or equal to 15%, less than or equal to 10%, less than or equal to 5%, less than or equal to 1%) change in capacity. In some embodiments, an electrochemical cell may be cycled greater than or equal to 1 cycle, greater than or equal to 20 cycles, greater than or equal to 50 cycles, greater than or equal to 100 cycles, greater than or equal to 150 cycles, greater than or equal to 200 cycles, greater than or equal to 250 cycles, greater than or equal to 300 cycles, greater than or equal to 350 cycles, or greater than or equal to 400 cycles. In some embodiments, an electrochemical cell may be cycled less than or equal to 400 cycles, less than or equal to 350 cycles, less than or equal to 300 cycles, less than or equal to 250 cycles, less than or equal to 200 cycles, less than or equal to 150 cycles, less than or equal to 100 cycles, less than or equal to 50 cycles, less than or equal to cycles, or less than or equal to 1 cycle. Combinations of the above-referenced ranges are also possible (e.g., greater than or equal to 1 cycle and less than or equal to 400 cycles). Other ranges are also possible.

In some embodiments, an electrochemical cell has a particular specific capacity. In some embodiment, the specific capacity is greater than or equal to 50 Wh/kg, greater than or equal to 100 Wh/kg, greater than or equal to 150 Wh/kg, greater than or equal to 200 Wh/kg, greater than or equal to 250 Wh/kg, greater than or equal to 300 Wh/kg, greater than or equal to 350 Wh/kg, greater than or equal to 300 Wh/kg, greater than or equal to 450 Wh/kg, greater than or equal to 475 Wh/kg, or greater than or equal to 500 Wh/kg. In some embodiments, the specific capacity is less than or equal to 500 Wh/kg, less than or equal to 475 Wh/kg, less than or equal to 400 Wh/kg, less than or equal to 350 Wh/kg, less than or equal to 300 Wh/kg, less than or equal to 250 Wh/kg, less than or equal to 200 Wh/kg, less than or equal to 150 Wh/kg, less than or equal to 100 Wh/kg, or less than or equal to 50 Wh/kg. Combinations of the above-referenced ranges are also possible (e.g., greater than or equal to 50 Wh/kg and less than or equal to 500 Wh/kg). Other ranges are also possible.

In some embodiments, an electrochemical cell has a particular volumetric capacity. In some embodiments, an electrochemical cell has a volumetric capacity of greater than or equal to 100 Wh/L, greater than or equal to 200 Wh/L, greater than or equal to 300 Wh/L, greater than or equal to 400 Wh/L, greater than or equal to 500 Wh/L, greater than or equal to 600 Wh/L, greater than or equal to 700 Wh/L, greater than or equal to 800 Wh/L, greater than or equal to 805 Wh/L, or greater than or equal to 1000 Wh/L. In some embodiments, an electrochemical cell has a volumetric capacity of less than or equal to 1000 Wh/L, less than or equal to 805 Wh/L, less than or equal to 800 Wh/L, less than or equal to 700 Wh/L, less than or equal to 600 Wh/L, less than or equal to 500 Wh/L, less than or equal to 400 Wh/L, less than or equal to 300 Wh/L, less than or equal to 200 or less than or equal to 100 Wh/L. Combinations of the above-referenced ranges are also possible (e.g., greater than or equal to 100 Wh/L and less than or equal to 1000 Wh/L). Other ranges are also possible.

The electrochemical cells described herein can be integrated into a battery (e.g., a rechargeable battery). In some embodiments, the electrochemical cells can be used to provide power to an electric vehicle or otherwise be incorporated into an electric vehicle. As a non-limiting example, electrochemical cells and systems described herein can, in some embodiments, be used to provide power to a drive train of an electric vehicle. The vehicle may be any suitable vehicle, adapted for travel on land, sea, and/or air. For example, the vehicle may be an automobile, truck, motorcycle, boat, helicopter, airplane, and/or any other suitable type of vehicle. In some instances, the electrochemical cells and systems may be used in battery applications. In some embodiments, a battery comprises one electrochemical cell. In some embodiments, a battery comprises, at least 10, 20, 30, 40, or 50 electrochemical cells.

The following examples are intended to illustrate some embodiments of the present disclosure, but do not exemplify the full scope of the disclosure.

### EXAMPLES

### Example 1

Mixtures were prepared by weighing out the appropriate amounts of potassium carbonate, lithium carbonate and aluminum oxide. The mixtures were then manually sieved (#80 sieve) together into a fine powder. The fine powders were then placed into jars and roller milled for 15 hours. Afterwards the mixtures were gently pressed into glassy carbon crucibles and placed into a pre heated furnace to melt the mixtures together. The furnace was ramped from 500° C. to 575° C. at a rate of 10° C./min and held at 575° C. for 3 minutes before the crucibles were removed from the furnace and the mixtures were allowed to cooldown in a dry and room temperature environment. Once cooled to room temperature the mixtures were ground and sieved into fine powders.

A mixture of potassium carbonate and lithium carbonate, but lacking aluminum oxide, subjected to the above procedure had an average powder conductive of 1.7×10⁻⁵ mS/cm. Aluminum oxide has a measured a powder conductivity at 2.2×10−6 mS/cm. A mixture of 40.4 wt % potassium carbonate, 21.6 wt % lithium carbonate, and 38 wt % aluminum oxide particles subjected to the above procedure exhibited a measured powder conductivity of 4.8×10⁻⁵ mS/cm.

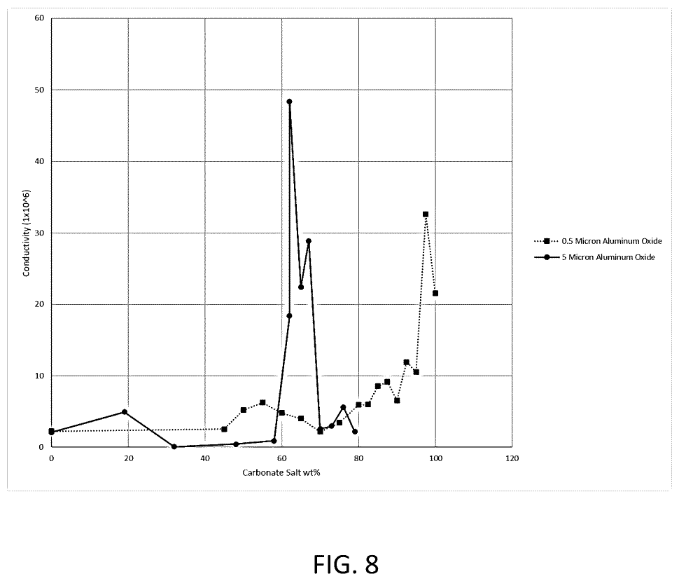

Further mixtures of potassium carbonate, lithium carbonate, and aluminum oxide particles were prepared and subjected to the above-described procedure to form compositions for forming protective layers. In each of the compositions, the potassium carbonate to lithium carbonate atomic mix ratio was 1:1. However, the different compositions varied in the average cross-sectional particle diameters of the aluminum oxide particles and the amount of aluminum oxide particles present. FIG. 8 shows the lithium ion conductivity as a function of carbonate salt content for mixtures including aluminum oxide particles having an average cross-sectional particle diameter of 0.5 μm and mixtures including aluminum oxide particles having an average cross-sectional particle diameter of 5 μm. As can be seen from FIG. 8, a composition including an average cross-sectional particle diameter of 0.5 μm exhibited a maximum lithium ion conductivity of 3.3×10⁻⁵ mS/cm at an aluminum oxide particle content of 2.5 wt %. As can also be seen form FIG. 8, a composition including aluminum oxide particles having an average cross-sectional particle diameter of 5 μm exhibited a maximum lithium ion conductivity of 4.8×10⁻⁵ mS/cm at an aluminum oxide particle content of 37.6 wt %.

### Example 2

Vacuum deposited electroactive layers comprising lithium having metallic lithium thickness of 5 μm and 15 μm were coated with compositions prepared as described in Example 1. One composition (“the control composition”) included 65 wt % potassium carbonate and 35 wt % lithium carbonate. Another composition (“the experimental composition”) included 40.4 wt % potassium carbonate, 21.6 wt % lithium carbonate and 38 wt % aluminum oxide having an average cross-sectional particle diameter of 5 μm. Both compositions were coated onto a vacuum deposited lithium anode by aerosol deposition to form a protective layer having a thickness of 2-4 μm.

The coated electroactive layers were placed into pouch cells with a NCM cathode and a polyolefin separator (9 μm thick). The cells had 99.4 cm² active electrodes area and contained 0.5 mL of electrolyte. The electrolyte comprised LiPF₆ at 12.5 w %, fluoroethylene carbonate at 17.5 w %, and dimethyl carbonate at 70.1 w %.

The resultant cells were cycled under an anisotropic pressure of 12 kg/cm². The cycling was performed according to two different protocols. Protocol 1 was performed for electrochemical cells including a 5 μm-thick metallic lithium layer and is as follows: charging at 75 mA to 4.4 V and discharging at 300 mA to 3.0 V. Protocol 2 was performed for electrochemical cells including a 15 μm-thick metallic lithium layer and is as follows: charging at 120 mA to 4.4 V and discharging at 120 mA to 3.0 V. The initial cell capacity was 400 mAh for both conditions for both types of cells. The cells were cycled to cutoff capacity of 300 mAh and cycle life was determined at this point.

When cycled according to Protocol 1, cells comprising protective layers having the control composition exhibited a cycle life of 53 cycles. By contrast, cells comprising protective layers having the experimental composition cycled according to Protocol 1 exhibited a cycle life of 174 cycles.

When cycled according to Protocol 2, cells comprising protective layers having the control composition exhibited a cycle life of 18 cycles. By contrast, cells comprising protective layers having the experimental composition cycled according to Protocol 2 exhibited a cycle life of 37 cycles.

Thus, electrochemical cells including protective layers comprising both carbonate salts and ionically insulating particles showed substantial advantages in cell performance compared to similar electrochemical cells including protective layers lacking the ionically insulating particles.

### Example 3. Determination of Recharge Ratio and Columbic Losses of VDLi Electrodes Coated with Protective Layers

Electrochemical cells having 15 μm-thick electroactive layers comprising lithium were fabricated as described in Example 2. These cells were then cycled for 30 cycles according to Protocol 2. The recharge ratio and columbic losses across these cycles were calculated. The recharge ratio (RR) was defined as the ratio of discharge capacity at cycle n to subsequent charge capacity, or charge capacity at cycle n+1; whereas the relative coulombic loss needed to compensate at subsequent charge was calculated using (1−RR).

For the first 30 cycles, the average recharge ratio and columbic loss for the cells including protective layers having the experimental composition were 0.99949 and 0.00051/cycle, respectively. By contrast, otherwise-equivalent electrochemical cells lacking a protective layer exhibited average recharge ratios and columbic losses of 0.99609 and 0.00391/cycle, respectively.

Thus, electrochemical cells including protective layers comprising both carbonate salts and ionically insulating particles showed substantial advantages in average recharge ratio and columbic losses compared with similar electrochemical cells lacking protective layers.

While several embodiments of the present disclosure have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present disclosure. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present disclosure is/are used. Those skilled in the art will recognize, or be able to ascertain using no more than routine experimentation, many equivalents to the specific embodiments of the disclosure described herein. It is, therefore, to be understood that the foregoing embodiments are presented by way of example only and that, within the scope of the appended claims and equivalents thereto, the disclosure may be practiced otherwise than as specifically described and claimed. The present disclosure is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

In cases where the present specification and a document incorporated by reference include conflicting and/or inconsistent disclosure, the present specification shall control. If two or more documents incorporated by reference include conflicting and/or inconsistent disclosure with respect to each other, then the document having the later effective date shall control.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.”

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

When the word “about” is used herein in reference to a number, it should be understood that still another embodiment of the disclosure includes that number not modified by the presence of the word “about.”

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. An article for use in an electrochemical cell, comprising:
an electroactive layer comprising lithium; and
a protective layer comprising a ceramic and a plurality of ionically insulating particles,
wherein each particle in the plurality of ionically insulating particles comprises a surface,
wherein the ceramic coats at least a portion of the surfaces of the ionically insulating particles,
wherein the ionically insulating particles and having surfaces coated by the ceramic strain the crystal lattice structure of the ceramic coating their surfaces, and
wherein the protective layer is conductive to lithium ions.

2. An article for use in an electrochemical cell, comprising:
an electroactive layer comprising lithium; and
a protective layer comprising a lithium aluminate,
wherein the protective layer is conductive to lithium ions.

3. An article, comprising:
an electroactive layer comprising lithium; and
a protective layer comprising a ceramic and a plurality of ionically insulating particles,
wherein the ceramic comprises an alkali metal carbonate and/or an alkaline earth metal carbonate,
wherein the plurality of ionically insulating particles comprises aluminum oxide, and
wherein the protective layer is conductive to lithium ions.

4-8. (canceled)

9. The article of claim 1, wherein the ceramic comprises an alkali metal carbonate, and wherein the alkali metal carbonate is potassium carbonate.

10. The article of claim 1, wherein the ceramic comprises an alkali metal carbonate, and wherein the alkali metal carbonate is lithium carbonate.

11. The article of claim 1, wherein the ceramic comprises at least two alkali metal carbonates.

12. The article of claim 11, wherein the at least two alkali metal carbonates are present in the protective layer at an atomic ratio of between 1:10 and 10:1.

13. The article of claim 1, wherein the ceramic is present in the protective layer at a concentration of between 60 wt % and 98 wt % versus the total weight of the protective layer.

14. (canceled)

15. The article of claim 1, wherein the particles are porous.

16. The article of claim 1, wherein the particles have an average cross-sectional diameter of between 0.2 μm and 10 μm.

17. The article of claim 1, wherein the ionically insulating particles comprise silica.

18. The article of claim 1, wherein the ionically insulating particles comprise aluminum oxide.

19. The article of claim 1, wherein the ionically insulating particles are non-conductive.

20. The article of claim 1, wherein the ionically insulating particles are insoluble in an electrolyte to be used with the article.

21. The article of claim 1, wherein the ionically insulating particles have a surface area of between 1 m²/g and 100 m²/g.

22. The article of claim 1, wherein the ionically insulating particles are present in the protective layer in an amount of between 2 wt % and 40 wt % versus the total weight of the protective layer.

23-41. (canceled)

42. The article of claim 1, wherein the protective layer has a thickness of between 0.1 μm and 10 μm.

43. The article of claim 1, wherein the protective layer comprises a plurality of pores.

44. (canceled)

45. The article of claim 1, wherein the article is present in an electrochemical cell, and wherein the protective layer increases a recharge ratio of the electrochemical cell by between 0.1% to 0.5% in comparison to an otherwise-equivalent electrochemical cell lacking the protective layer.

46. The article of claim 1, wherein the article is present in an electrochemical cell, and wherein the protective layer reduces a relative coulombic loss during recharging by a factor of between 5 and 8 in comparison to an otherwise-equivalent electrochemical cell lacking the protective layer.
